(19) United States
(12) Patent Application Publication
(10) Pub. No.: US 2013/0137078 A1
(43) Pub. Date: May 30, 2013

(54) EDUCATIONAL-SOCIAL NETWORK

(71) Applicants: Alexander Shustorovich, New York, NY (US); Olga Zakharova, Moscow (RU); Natalia Churakova, Moscow (RU)

(72) Inventors: Alexander Shustorovich, New York, NY (US); Olga Zakharova, Moscow (RU); Natalia Churakova, Moscow (RU)

(73) Assignee: PLEIADES PUBLISHING LIMITED INC., New York, NY (US)

(21) Appl. No.: 13/350,666

(22) Filed: Jan. 13, 2012

Related U.S. Application Data
(60) Provisional application No. 61/564,857, filed on Nov. 29, 2011.
(60) Provisional application No. 61/566,380, filed on Dec. 2, 2011.

(51) Int. Cl. G09B 7/00

(52) U.S. Cl. 434/362

(57) ABSTRACT

Systems and methods for collecting information about a student's educational and social activities from a plurality of networked sources, storing the information, and providing access to the information are provided. A collection component receives information associated with a student, including at least educational activity information. A portfolio component then associates the information in a portfolio for the student, which is stored in a data store, and an access component provide access to the portfolio. An educational activity component provides educational activities to the student and a social activity component provides a public interface and social activities for students.

### PRIORITY CLAIM

This application claims priority to U.S. Provisional Application Ser. No. 61/564,857, filed Nov. 29, 2011, entitled “Educational-Social Network,” and to U.S. Provisional Application Ser. No. 61/566,380, filed Dec. 2, 2011, entitled “Educational-Social Network,” the entireties of each of which are incorporated by reference herein.

### TECHNICAL FIELD

This disclosure relates to collecting information about a student's educational and social activities from a plurality of networked sources, storing the information, and providing access to the information.

### BACKGROUND

Conventional educational technologies utilize computer-aided systems; however, such technologies lack digital teaching aids oriented towards efficient instruction. In addition, conventional educational technologies lack an efficient and effective means to monitor and present not only educational progress of the student but social progress as well.

The above-described deficiencies of today's educational and related technologies are merely intended to provide an overview of some of the problems of conventional technology, and are not intended to be exhaustive. Other problems with the state of the art, and corresponding benefits of some of the various non-limiting embodiments described herein, may become further apparent upon review of the following detailed description.

### SUMMARY

The following presents a simplified summary of the disclosure in order to provide a basic understanding of some aspects of the disclosure. This summary is not an extensive overview of the disclosure. It is intended to neither identify key or critical elements of the disclosure nor delineate any scope particular embodiments of the disclosure, or any scope of the claims. Its sole purpose is to present some concepts of the disclosure in a simplified form as a prelude to the more detailed description that is presented later.

In various non-limiting embodiments, systems and methods are provided for an educational-social collection system that has various mechanisms of a social network and an educational network. In an example embodiment, a system comprises at least one processor configured to facilitate execution of one or more computer executable components. The one or more computer executable components comprise an educational-social collection component configured to receive student activity information for a student of a plurality of students. The student activity information includes educational activity information and social activity information. A portfolio component is configured to associate the student activity information in a portfolio stored in a data store for the student. An access component is configured to control access to the portfolio and the educational-social collection component.

In another example, a method for an educational social network system comprises receiving, by a computing device including a processor, student activity information associated with a plurality of students. The student activity information includes educational activity information and social activity information that relates to the plurality of students. The method includes coordinating communications with community groups, contest groups, project groups and a social group. The social group includes public communications among the plurality of students, teachers and parents. The method includes associating the student activity information with respective portfolios of the plurality of students, determining a level of authorization based on authentication information received from at least one student of the plurality of students, and providing access to the portfolios based on the level of authorization.

In another example embodiment, a computer readable storage medium comprising computer-readable instructions that, in response to execution, cause a computing system to perform operations. The operations comprise receiving student activity information associated with a student of a plurality of students, including educational activity information and social activity information. The educational activity information includes community information, contest information, and project information. The operations include associating the student activity information in portfolios respectively associated with the plurality of students, storing the portfolios in a data store, determining a level of authorization based on authentication information received from at least one student of the plurality of students, and providing access to the portfolios respectively based on the level of authorization.

The following description and the annexed drawings set forth certain illustrative aspects of the disclosure. These aspects are indicative, however, of but a few of the various ways in which the principles of the disclosure may be employed. Other advantages and novel features of the disclosure will become apparent from the following detailed description of the disclosure when considered in conjunction with the drawings.

### BRIEF DESCRIPTION OF THE DRAWINGS

FIG. 1 illustrates an example non-limiting educational system in accordance with an embodiment.

FIG. 2 illustrates an example non-limiting educational social network system in accordance with an embodiment.

FIG. 3 presents a non-limiting block diagram of an example configuration of components and sources of student activity information in accordance with an embodiment.

FIG. 4 illustrates another example non-limiting educational social network system in accordance with an embodiment.

FIG. 5 illustrates an example student interface for a student in accordance with an embodiment.

FIG. 6 illustrates an example teacher interface for a student in accordance with an embodiment.

FIG. 7 presents a block diagram of an educational social network system having a project component in accordance with an embodiment.

FIG. 8 presents a block diagram of an aspect of a project component in an educational social network system in accordance with an embodiment.

FIG. 9 presents a block diagram of another aspect of a project component in an educational social network system in accordance with an embodiment.

FIG. 10 presents a block diagram of another aspect of a project component in an educational social network system in accordance with an embodiment.

FIG. 11 illustrates an example methodology for receiving, storing, and distributing student information in accordance with educational social network systems.

FIG. 12 is a block diagram representing an exemplary non-limiting networked environment in which various embodiments can be implemented.

FIG. 13 is a block diagram representing an exemplary non-limiting computing system or operating environment in which various embodiments may be implemented.

### DETAILED DESCRIPTION

Various non-limiting embodiments of systems, methods, and apparatus presented herein couple portable educational terminal(s) with a teacher interface by way of an interactive, real-time educational system.

In the following description, numerous specific details are set forth to provide a thorough understanding of the embodiments. One skilled in the relevant art will recognize, however, that the techniques described herein can be practiced without one or more of the specific details, or with other methods, components, materials, etc. In other instances, well-known structures, materials, or operations are not shown or described in detail to avoid obscuring certain aspects.

Reference throughout this specification to “one embodiment,” or “an embodiment,” means that a particular feature, structure, or characteristic described in connection with the embodiment is included in at least one embodiment. Thus, the appearances of the phrase “in one embodiment,” or “in an embodiment,” in various places throughout this specification are not necessarily all referring to the same embodiment. Furthermore, the particular features, structures, or characteristics may be combined in any suitable manner in one or more embodiments.

As utilized herein, terms “component,” “system,” “platform,” “node,” “layer,” “selector,” “interface,” and the like are intended to refer to a computer-related entity, hardware, software (e.g., in execution), and/or firmware. For example, a component can be a processor, a process running on a processor, an object, an executable, a program, a storage device, and/or a computer. By way of illustration, an application running on a server and the server can be a component. One or more components can reside within a process, and a component can be localized on one computer and/or distributed between two or more computers.

Further, these components can execute from various computer readable media having various data structures stored thereon. The components can communicate via local and/or remote processes such as in accordance with a signal having one or more data packets (e.g., data from one component interacting with another component in a local system, distributed system, and/or across a network, e.g., the Internet, with other systems via the signal).

As another example, a component can be an apparatus with specific functionality provided by mechanical parts operated by electric or electronic circuitry; the electric or electronic circuitry can be operated by a software application or a firmware application executed by one or more processors; the one or more processors can be internal or external to the apparatus and can execute at least a part of the software or firmware application. As yet another example, a component can be an apparatus that provides specific functionality through electronic components without mechanical parts; the electronic components can include one or more processors therein to execute software and/or firmware that confer(s), at least in part, the functionality of the electronic components.

The word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive—in a manner similar to the term “comprising” as an open transition word—without precluding any additional or other elements.

Artificial intelligence based systems, e.g., utilizing explicitly and/or implicitly trained classifiers, can be employed in connection with performing inference and/or probabilistic determinations and/or statistical-based determinations as in accordance with one or more aspects of the disclosed subject matter as described herein. For example, an artificial intelligence system can be used, via teacher interface 130 (see below), to automatically track, via a network computing environment and/or a cloud computing environment, tracking information, e.g., a location of an educational terminal, information related to a lesson plan, student related performance, etc. In another example, the artificial intelligence system can automatically select individualized lesson plan(s) for respective students in response to the tracking information.

As used herein, the term “infer” or “inference” refers generally to the process of reasoning about, or inferring states of, the system, environment, user, and/or intent from a set of observations as captured via events and/or data. Captured data and events can include user data, device data, environment data, data from sensors, sensor data, application data, implicit data, explicit data, etc. Inference can be employed to identify a specific context or action, or can generate a probability distribution over states of interest based on a consideration of data and events, for example.

Inference can also refer to techniques employed for composing higher-level events from a set of events and/or data. Such inference results in the construction of new events or actions from a set of observed events and/or stored event data, whether the events are correlated in close temporal proximity, and whether the events and data come from one or several event and data sources. Various classification schemes and/or systems (e.g., support vector machines, neural networks, expert systems, Bayesian belief networks, fuzzy logic, and data fusion engines) can be employed in connection with performing automatic and/or inferred action in connection with the disclosed subject matter.

In addition, the disclosed subject matter can be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, computer-readable carrier, or computer-readable media. For example, computer-readable media can include, but are not limited to, magnetic storage devices, e.g., hard disk; floppy disk; magnetic strip(s); optical disk (e.g., compact disk (CD), digital video disc (DVD), Blu-ray Disc™ (BD)); smart card(s); and flash memory device(s) (e.g., card, stick, key drive); and/or a virtual device that emulates a storage device and/or any of the above computer-readable media.

Aspects, features, and/or advantages of the disclosed subject matter can be exploited in substantially any wireless telecommunication or radio technology, e.g., wireless fidelity (Wi-Fi™); Bluetooth™, Worldwide Interoperability for Microwave Access (WiMAX™); Enhanced General Packet Radio Service (Enhanced GPRS); Third Generation Partnership Project (3GPP) Long Term Evolution (LTE™); Third Generation Partnership Project 2 (3GPP2); Ultra Mobile Broadband (UMB); 3GPP Universal Mobile Telecommunication System (UMTS); High Speed Packet Access (HSPA); High Speed Downlink Packet Access (HSDPA); High Speed Uplink Packet Access (HSUPA); LTE™ Advanced (LTE-A), Global System for Mobile Communication (GSM), Near Field Communication (NFC), etc.

Aspects of systems, apparatus, and processes explained herein can constitute machine-executable instructions embodied within a machine, e.g., embodied in a computer readable medium associated with the machine. Such instructions, when executed by the machine, can cause the machine to perform the operations described. Additionally, the systems and processes can be embodied within hardware, such as an application specific integrated circuit (ASIC) or the like. Moreover, the order in which some or all of the process blocks appear in each process should not be deemed limiting. Rather, it should be understood by a person of ordinary skill in the art having the benefit of the instant disclosure that some of the process blocks can be executed in a variety of orders not illustrated.

As an overview of the various embodiments presented herein, to correct for the above identified deficiencies of existing mechanisms of educational systems, various systems and methods of providing an educational-social network are disclosed. An education system, for example, provides a community component a contact component and a project component with a mechanism that exports the results of student activities to a student's portfolio. The educational-social network combines educational components related to educational activities and social activity components related to social activities, and presents the combination in each student's portfolio. In this manner, social activities online are able to provide educational assessments, together with educational projects, and provides an inclusive learning environment.

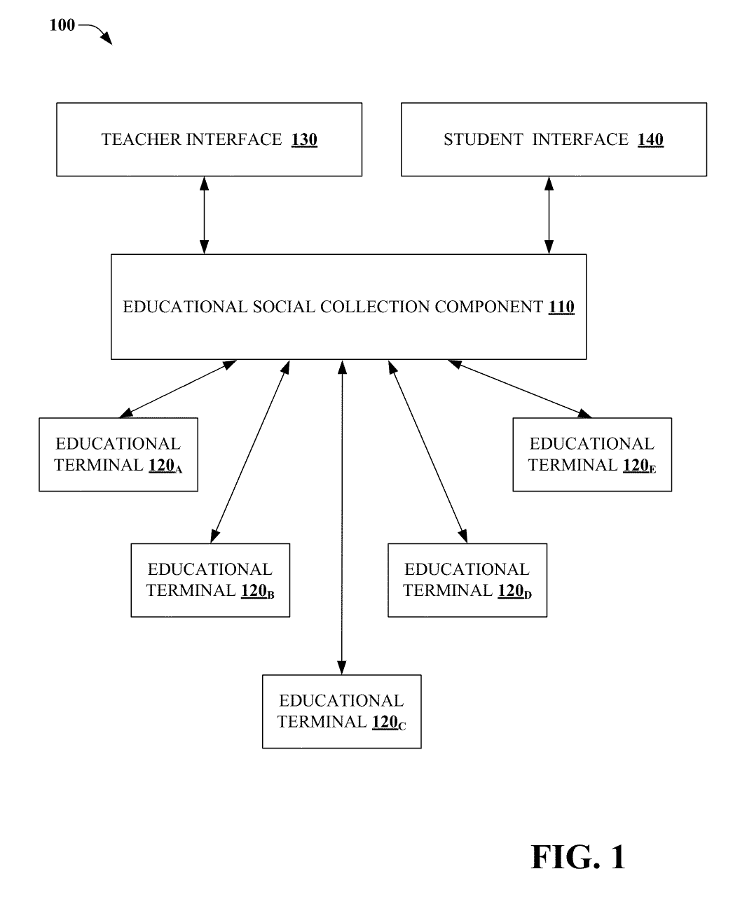

Now referring to FIG. 1, an educational system 100 is illustrated, in accordance with one aspect of an exemplary embodiment. Educational system 100 incorporates educational activities as well as social activities to educate and provide students and teachers with interactive tools for educating students beyond the traditional rote learning methods to one of modern interaction. The educational system 100 includes an educational social collection component 110, which can provide an interactive, real-time, learning resource to educational terminal(s) within a classroom environment, e.g., school, university, etc. For example, educational system 100 can include server(s), computing device(s), etc. that can be coupled to at least one database. Further, educational system 100 authorizes a first communication between educational social collection component 110 and educational terminals 120_{A-E}, e.g., utilizing the server(s) and the at least one database, within a network computing environment, e.g., via TCP/IP based technology, the Internet, cloud computing environment, etc.

In one aspect of the system 100, the first communication can include a log-in event, for example, requiring an alphanumeric registration, voice activated registration, or biometric registration from an associated educational terminal. The log-in event includes receiving authentication information (e.g., user identification, password, biometric, secret key, random password, etc.) for a level of authorization associated with a student, teacher or parent. The level of authorization, for example, is personalized interface or level that includes denial of access to the system, complete access to the totality of the system's resources, or an intermediate level that is personalized depending upon the individual and the authentication information received. In another aspect, the educational terminal can include more than one display and more than one input device. For example, the educational terminal can include two screens representing respective pages of a text book. Further, the educational terminal can include an input device, notepad, virtual keyboard, etc. to receive information associated with the log-in event, student responses, etc.

Educational social collection component 110 can further authorize, via the network computing environment, a second communication between educational activity component 110, a teacher interface 130 and a student interface 140. The second communication includes a log-in event, for example, requiring an alphanumeric registration, voice activated registration, biometric registration or other manner of registration from teacher interface 130 or student interface 140. Further, the second communication includes information, e.g., stored in the database, and associated with a lesson plan, instructional material, classroom communication, student activities, student organization or community membership activities, project activities, etc. that can be customized towards a student of a respective educational terminal and updated based on the student's involvement or teacher input.

For example, educational social collection component 110 is operable to transfer, via the network computing environment, educational path information between an educational terminal, e.g., 120_{A}, 120_{B}, 120_{C}, 120_{D}, 120_{E}, etc. and educational social collection component 110 in response to the second communication. For example, the educational path information can include digitized textbook information, individualized instructional material, e.g., related to a lesson plan associated with the educational terminal, student response(s), etc.

In another aspect, educational activity component 110 can authorize, via the network computing environment, a communication between the student interface 140, teacher interface 130 and the educational terminal, e.g., 120_{A}, 120_{B}, 120_{C}, 120_{D}, 120_{E}, etc. The communication can include information and/or feedback related to coursework, e.g., of a lesson plan, assignments, etc. communicated from the teacher interface to the educational terminal, and also communicated to the student interface 140. In addition, the communication can include questions, messages, information, etc. sent from a student associated with the educational terminal to a teacher (via teacher interface 130 or student interface 140). The communication also includes information and/or feedback related to social activities that may be part of coursework, which include online activities via a network with networking tools. The tools include, for example, communication tools, search engines, blog tools for interacting with a blog, contests tools for interacting with contests presented at the teacher interface 130 and/or student interface 140. Other tools are also provided for interactions between student activities that are social and education, teachers and parents, which will be further detailed below.

In yet another aspect, teacher interface 130 can include a teacher private office, which can host the teacher's timetable, and include class registers of classes taught by the teacher. Teacher interface 130 can also include a teacher private archive, which can host additional teaching materials, as well as confidential data about students, personal observations, conclusions, etc. In one aspect, teacher interface 130 can include: tools to monitor student progress in each class; tools to obtain test materials; tools to obtain test reports on questions that are checked automatically; tools to convert test results into a five-grade mark; tools to deliver the final class-by-class mark to the class register and to the grade book; tools to enter comments on completed tasks; and tools to deliver comments to students, their parents, school administration, etc. In addition, a teacher profile is provided having information about the individual teacher or photos related, in which the teacher interface 130 corresponds to.

The student interface 140 includes similar tools as the teacher interface for interaction with the teacher's course plan, assignments, activities, out-of-class activities, school community involvement (e.g., clubs, sports, etc.). The student interface 140 can include presentations, homework activities, assignment activities, activity grades, test material, quiz material, social interactions with other users (teacher, student, parent users), research time, passes to library materials, as well as tools such as search engines, authorizations, presentation tools, editing tools, commentary tools, communication tools, networking tools, etc. Voting mechanism and rating tools for grading among peers and teachers are also provided.

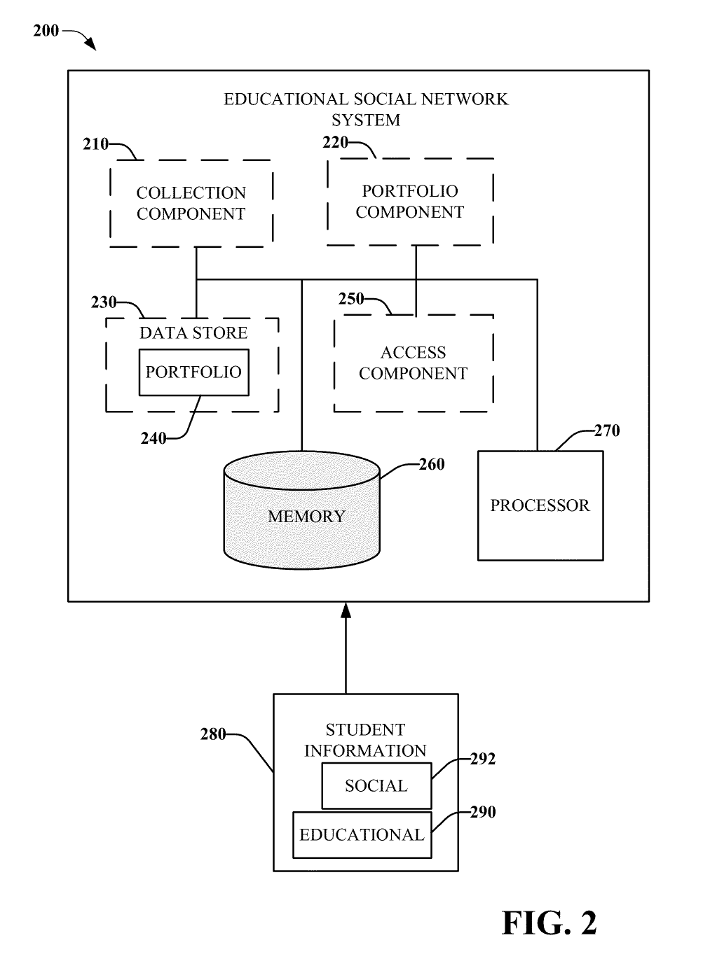

Referring now to FIG. 2, an educational social network system 200 is illustrated that facilitates collecting, storing, and accessing information about a student. Aspects of the systems, apparatuses or processes explained in this disclosure can constitute machine-executable component embodied within machine(s), e.g., embodied in one or more computer readable mediums (or media) associated with one or more machines. Such component, when executed by the one or more machines, e.g., computer(s), computing device(s), virtual machine(s), etc. can cause the machine(s) to perform the operations described. System 200 can include memory 260 for storing computer executable components and instructions. A processor 270 can facilitate operation of the computer executable components and instructions by the system 200.

In an embodiment, system 200 employs an educational social collection component 210, a portfolio component 220, a data store 230, and an access component 250. Memory 260 stores on the computer the above executable components, and processor 260 is configured to execute the above computer executable components stored in the memory 260. In an aspect, the collection component 210 is configured to receive information 280 associated with a student, such as educational activity information as well as social activity information. In turn, the portfolio component 220 is configured to associate the information in a portfolio 240 for the student, wherein the data store 230 archives a plurality of portfolios that are each associated with, individualized and/or personalized to each student among all the students of a school, university, orphanage or other educational entity. Thus, data store 230 is configured to store the portfolio(s) 240 and the access component 250 is configured to provide access to the portfolios.

In an embodiment, educational social network system 200 can be provided in a public or private environment/network, such as within a local area network (LAN), personal area network (PAN), campus area network (CAN), metropolitan area network (MAN), a wide area network (WAN), or other network. For example, a private entity such as a school or college may employ a student portfolio system 200 to facilitate collection, storage and distribution of student information 280, which includes social and educational activities related to an individual student's educational environment. According to this example, the educational social network system can be provided on a server for the school and accessed via a private network, such as an intranet associated with the school. In another aspect, the educational social network system 200 is employed by a variety of different entities over a public network, such as the world wide web (i.e. Internet). For example, a variety of different schools, universities, and etc. employs the educational social network system 200 via an internet to into collect, store, and distribute information about students for the variety of different schools. In particular, the educational social network system is configured to receive and distribute student information over a networked environment via a cloud computing environment (e.g., via an internet based computing environment, via a Transmission Control Protocol (TCP), via an Internet Protocol (IP), etc.)

In another embodiment, the collection component 210 receives information related to a particular student, which is then used to establish and/or develop a student portfolio 240 associated with the particular student among a plurality of portfolios associated with various other individual students. The student information 280 includes student activity information, which includes both educational activity information 290 and social activity information 292. Educational activity information 290, for example, includes activities taking place within the school educational environment, such as school clubs or communities within the school, school contests, school projects, and other events that students take part in, such as student representative elections, band, choir, drama, sports, etc. The student activity information can further include, for example, a social level of participation in a social activity, a community level of participation, a contest level of participation in a competition, and/or a project level of participation in a project, where each level of participation provided includes not participating, participating, or some other indication that a student is not or is contributing to an activity respectively.

Students naturally socialize outside of the school environments, and thus, the educational social network system 220 encompasses these activities as part of the educational environment in order to better equip students for life outside of the school environment. For example, teachers assign social activities through social networking tools provided in the system 200 and enable students to become familiar with these tools. Social activity information 292 is therefore gathered through the system 200 by the educational social collection component 210 and presented in a teacher interface and a student interface for evaluations, presentations, and out-of-school activities corresponding to individual student portfolios 240.

As used herein, a student or pupil includes a person who attends or is enrolled at an educational institution for the purpose learning. A student can include an individual who is associated with an educational institution for the purpose of learning who is not actively participating in learning for an interrupted period of time, such as a period of time where classes are not held, or a period of time where the student is placed on leave, or probation. A graduated student is a person who attended or was enrolled at an educational institution in the past. An educational institution can include but is not limited to a pre-school, a primary school, a secondary school, a high school, a college, a university, a vocational school, an alternative school, a home school, an online school, a government school, a military school, a business school, or any other organized learning institution.

In one aspect, a student can be enrolled at multiple educational institutions over time. For example a student can be enrolled at multiple different educational institutions in a consecutive manner throughout his or her lifetime. According to this example, a student may attend pre-school, then primary school, then secondary school, then university. According to this aspect, an individual can retire from the role of a student at periods of time where the individual is not enrolled at an educational institution and re-enter the role of student when the individual again enrolls at an educational institution.

A portfolio or student portfolio 240 includes a data file associated with an individual who is a student and includes information about the student. In other words, a portfolio 240 is associated with a single individual and includes information about that individual. A student portfolio 140 serves as a dynamic tool to organize and view information about a student's educational and/or social history. In particular, the educational and social profile of a student is formed over the whole period of the student's educational career using the changing and ever-supplemented base of individual information. The portfolio 240 serves to store this base of individual data in an organized manner, while collection component 210 receives the information 280.

In another aspect, each portfolio 240 of each student remains associated with the individual student when the student graduates or is no longer enrolled at the educational institution. In yet another aspect, the portfolio for an individual remains associated with the individual as the individual enrolls at multiple schools throughout his or her lifetime. For example, once a portfolio 240 is established for a student at a first educational institution, the portfolio 240 can remain associated with the student when the student attends another educational institution. According to this aspect, a student's portfolio serves as a compilation of information about the student over the course of the student's educational history and can be a source of reference for future employment, class reunions or other student needs. In another aspect, a student can be associated with a different portfolio 240 for each educational institution the student attends.

A portfolio 240 can include a variety of information about a student. In an aspect, a student can have a portfolio stored in data store 230, which is continuously developed and updated over the course of the student's educational career. For example, when an individual enrolls at an educational institution, the educational institution can establish a basic portfolio for the student comprising of various categories of information. As the student advances in his or her educational career at the educational institution (or a new educational institution for that matter), the collection component 210 can receive information to apply to the various categories and thus enable the growth and development of a rich student portfolio.

In another embodiment, a student portfolio 240 can include, and thus the collection component 210 can receive, educational activity information. Educational activity information can include any information associated with the progress of a student's education, such as participation in educational activities. For example, educational activities can include classes, other educational activities related to classes, other educational activities not related to classes, educational events, educational seminars, tutoring, educational projects, library visits, laboratory visits, studio visits, research, educational competitions, reading activities, study hall attendance, study group attendance, library pass control, and etc.

In an aspect, educational activity information includes qualitative academic performance information. Qualitative academic performance information relates to the quality of a student's academic performance in educational activities including the types of academic classes and activities a student participates in, scores or grades received in those classes and activities, and scores or grades received on academic evaluations. For example, an academic evaluation can include but not limited to a test, an exam, a quiz, a project, a paper, a speech, a performance, a contest, competition and etc. Academic performance information can include specific scores for a specific evaluation or assignment and/or general scores regarding overall academic performance. For example, academic performance information can include a final class grade or final exam score as well as a breakdown of scores on various assignments, tests, and quizzes contributing to the final class grade.

A score for an academic evaluation can include a point score, a percentage, or a grade. In addition, academic performance information can account for the quality of a score. In particular, academic performance information can weigh a score based on the difficulty of the academic evaluation used to generate the score and/or the subject matter or activity associated with the academic evaluation. For example, a final grade in an advance math class may have a higher weight then a final grade in a performance arts class. In another example, qualitative academic performance information can include scores received on activities, tests, quizzes or combination of participation in such activities that are provided on an interactive electronic educational website, for example.

In addition, qualitative academic performance information can account for ratings or reviews received by peers and/or teachers regarding a student's academic performance in general or with respect to an educational activity. In particular, in addition to numeric data on the quality of education, such as points and grades, the collection component can automatically receive teachers' commentaries that teachers enter in an electronic register against the last name of each student at the end of each term or each trimester. Similarly, the collection component 210 can also automatically receive teachers' opinions on students' competition entries and work in projects, (i.e. commentaries by teachers who supervise competitions and projects). Additionally, peer review and commentary can also be received and provided to the individual student's portfolio.

In another aspect, educational activity information can include quantitative academic performance information. Quantitative academic performance information represents an amount of participation in educational activities. For example, quantitative academic performance information can include transcript information, including degrees received, diplomas awarded, commendation certificates, a number of classes taken, and types of classes taken. In another example, quantitative educational activity information can include a number of activities participated in, a number of competitions participated in, a number of workshops attended, a number of seminar attended, a number of online assignments fulfilled, and etc., as well as particular activities and assignments related to each. In another example, the quantitative educational activity information can include at least one of: participation in or attendance of an educational event or activity, participation in a competition or a project; receipt of an achievement award, participation in a forum, time spent at a library time spent at a laboratory or studio, or reading activity, and etc.

In another embodiment, a student portfolio 240 can include, and thus the collection component 210 can receive student information 280 including, social activity information. Social activity information 292 can include any type of information related to participation in a social activity, wherein a social activity includes an activity that facilitates interaction and communication with others. For example, social activity information 292 can include, but is not limited to, participation in an extracurricular activity, participation in a social event or activity (i.e. a dance, a mixer, a game event, a sporting event, a fundraiser, a play, and etc.), participation in a competition or project, or participation in a coterie.

Social activity information 292 can also be qualitative or quantitative. For example, qualitative social activity information can account for the quality of social activity of a student with respect to participation in a social activity measured by the accumulation of friends and contacts, invitation to additional social events, or acceptance into clubs, communities or out-of-school organizations. In addition, qualitative assessments of social activity could be based on assignments provided by instructors or teachers at a class level, at a community or club level, a school level, and such interactions hosted by the network system 200 could be evaluated according to teacher lesson plans and objectives for the students. Qualitative social activity information can also be provided in the form of commentary provided by peers, teachers, or supervisors regarding the quality of a student's social performance in social activities. Quantitative social activity information can include the number of social activities attended by or participated in by a student, as well as the types of those activities.

Still, in another aspect, a student portfolio 240 can include, and thus the collection component 210 can receive, additional personal information about a student, which may be relevant to the student's educational and social performance. For example, additional information can include profile information related to the student, medical information about a student, such as current vaccinations, diseases, or other medical conditions, including psychological conditions, as well as medications taken by a student. In another example, other personal information can include information related to a student's behavioral activities, such as a student's criminal record, a student's policy violations, a student's detentions and/or expulsions, and etc. In another example, additional personal information can include information about a student's background, or family life.

In addition, portfolio component 220 is configured to associate student information 280 received by collection component 210 in a portfolio for a student. It should be appreciated that although system 200 may be described with reference to a student, system 200 can accommodate a plurality of students. In particular, collection component 210 can receive information about a plurality of students. For example, collection component 210 can receive information about the multiple students attending a specific educational institution. In another aspect, collection component 210 can receive information about a plurality of students attending a plurality of different educational institutions.

In an embodiment, portfolio component 220 is configured to identify a student for which student information is received and associate the information with the portfolio of that student. In an aspect, the portfolio component 220 can identify a student by a name or last name associated with the student and the information received. In another aspect, the portfolio component 220 can identify a student by an account number or IP address associated with information received and associated the information the portfolio of that student as identified by the students name, account number, IP address, or other identification number for the student.

In another aspect, wherein the portfolio component 220 is further configured to organize the portfolio into categories based on features of the student information received. For, example, the portfolio component 220 is configured to classify information received by collection component 210 into one or more predetermined classifications and file the information based on the classification or categories, which are further detailed below. In another aspect, the portfolio component can organize and file received student information 280 based on its origination source.

Data store data store 230 is configured to store portfolios 140 for students as well as additional information employed by system 200. Additional information can include student identification information, information associating students with electronic resources, classes, teachers and administrators, and authorization information. Data store 230 can further store information regarding communication procedures associated with distributing information associated with a student portfolio.

In an aspect, the information stored by data store 230 is centrally available through the system. For example, data store 230 can be provided on a server computer that can be accessed via a network. The network can be public or private. According to this example, data store 230 can be provided on a server computer that integrates system 200. In another aspect, data store 130 can include a federation of multiple data stores internal and/or external to educational social network system 200.

Access component 250 is configured to provide access to data store 230, and in particular, the portfolio's 240 stored therein. In an aspect, access component is configured to provide access to authorized users of the system 200 and authorized users of specific student portfolios 240 and/or to tools provided for communities, contests, and projects. For example, those authorized to access a student portfolio can include the student to which the portfolio belong, a graduated student of associated with a portfolio, parents of the student, teachers or supervisors of the student, and administrative personnel. A variety of mechanisms can be employed to authorize access to a student portfolio. For example, users can be authorized by providing authentication information to the access component in the form of an identification name/number and a password. In an aspect, the identification number and/or password can be associated with a client device, (e.g. an IP address or phone number) that is employed to interact with system 200.

A client device can include any suitable computing device associated with a user and configured to interact with system 200 (or additional systems described in this disclosure). For example, a client device can include a desktop computer, a laptop computer, a smart-phone, a tablet personal computer (PC), or a PDA. As used in this disclosure, the terms “individual” or “user” refer to a person, entity, system, or combination thereof that employs the system 200 (or additional systems described in this disclosure). In an aspect, a client device can be configured to access a portfolio 140 via a network such as for example the Internet, intranet, or cellular service.

In an embodiment, access component 250 can be configured to provide different levels of access to portfolio 240. A level of access can directly relates to the manner in which a user can interact with a portfolio. For example, a student for who a portfolio belongs may be able to view his or her portfolio and edit and provide information for the portfolio with respect to predetermined sections. According to this example, the student may be authorized to write notes in a journal area. However, the student may be restricted from editing and manipulating certain information section of his or her portfolio, such as those sections pertaining to grades or medical information, based on the student's access information. On the contrary, a teacher or administrator may have a different level of access which permits the teacher or administrator to edit grade or medical information.

Student portfolio 240 described herein serve a variety of purposes. In an aspect a student portfolio works as a tool of data collection, that is, accumulation, storage, and online translation of an individual school student's database about various directions and fields of the student's educational and extra-curricular social activities. In another aspect, student portfolio serves as a mirror of an integral picture (way of representing and interpreting) a student's educational and social actions and achievements. In yet another aspect, a student portfolio serves as a tool of social control and social influence on a student on the part of adults and administrators in order to correct or guide the student's educational and/or social activities.

As a data collection tool, the student portfolio collects and stores individual data about the activities and successes of a student in education and social life, and provides honest accounting for quantitative and qualitative indicators of students' educational and social actions. Student portfolio systems disclosed herein automatically record in a portfolio for a student, real facts of the student's actions performed (for example, the fact of going to the library, the fact of taking part in a competition or a project, as well as all other facts that are recorded automatically), as well as messages about facts that are generated by the student or the students teacher (for example, a message about visiting a workshop or a coterie, a message about participation in a competition that was held outside the given educational-social network). Thus, student portfolio systems disclosed herein accumulate quantitative indicators of a school student's social activities in the portfolio.

At the same time, the systems disclosed herein also accumulate qualitative indicators of a student's educational and social activities (i.e. the systems automatically records points and updates their scores) that the student receives as the result of written tests, final tests, and final results in various subjects at the end of each academic term or each trimester, as well as points that the student receives for participation in competitions and projects following the voting results. In addition to numeric data on the quality of education, such as points and grades, the systems also automatically record subject teachers' commentaries that these teachers enter in an electronic register against the last name of each student at the end of each term or each trimester. Similarly, the systems also record teachers' opinions on students' competition entries and work in projects (i.e. commentaries by teachers who supervise competitions and projects. In addition, the portfolio also accumulates quantitative data about reading activity and qualitative indicators of students' reading competences, which are automatically entered into the portfolio from an electronic interactive library.

As a way of representing and interpreting a student's educational and social actions and achievements, portfolios 240 provide a medium for a student to view the integral picture of his or her educational and social life. Moreover, the picture can be accessed not only by the student but also by his or her form master and parents. As a result, the student will be motivated by an improved degree of students' social responsibility before his or her school community and parents.

Further, the fact that school students themselves can take part in the formation of this picture and correct the already created and formed picture strengthens the self-esteem of students and serves either as an incentive to show their social activity or as an incentive to create an illusion of social activity, which is also an important aspect in the process of the social development of school students (the recognition by a school student of the necessity to create such an illusion is the manifestation of his/her social maturity). For example, students can elect to take part in additional educational and social activities in order to improve their overall portfolio. Moreover, the complex structure of the portfolio, such as the fact that the portfolio includes various types of social activities of students and not only their educational achievements, is an important compensatory tool in those cases where the low-level results of a student's educational activity are compensated by his/her activities in various spheres of social life. For example, if a student is unable to achieve high educational results, he or she may improve his or her portfolio's rating by applying for various social activities. In another example if a student is unable to achieve good results in various social activities, he or she can display enough social maturity not so much by participating as by logging in to various portfolio sections and improving the quantitative indicators of his or her social activity.

Portfolios described herein can also serve as a tool of social control. The electronic data collection and storage features of systems disclosed herein make it possible to create an honestly formed portfolio of a school student at least in part because aspects of data collection are beyond student control. Since the portfolio provides for both general and differentiated pictures of a student's educational and social activities at any stage of the student's stay at school, it can be thoroughly analyzed both by adult members of the school community/the form master and subject teachers (on the initiative and with assent of the form master), the school administration, and the school psychologist/and by the student's parents or those who take care of his or her life and self-determination. For the educational community and parents, the portfolio may thus become a tool of social influence on school students, as well as a tool of planning their future.

On the other hand, an honestly formed electronic portfolio may accompany a school student in his or her transfer to another school (this will help the teachers' community of that other school to painlessly adapt the newcomer to a new team), on his or her entry to a higher educational establishment (the portfolio's rating discussed supra, may serve as a component of an admittance requirement), and under military conscription (the health certificate of a school student in this latter case will help save on medical examinations).

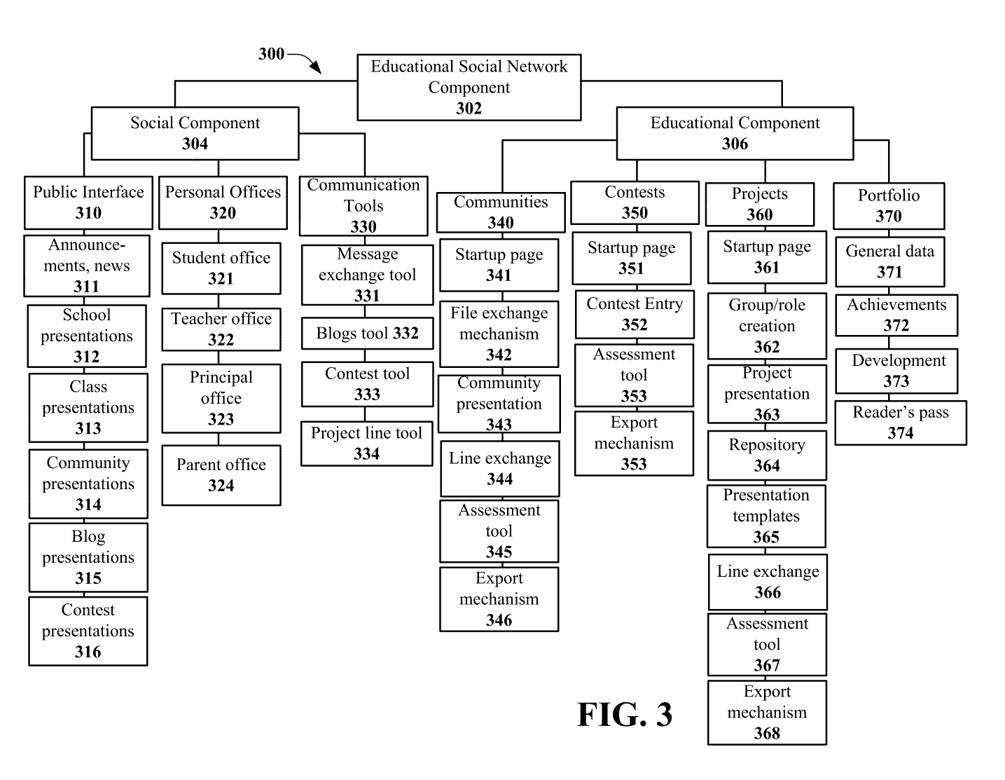

FIG. 3 presents a block diagram of one aspect of an exemplary embodiment of an educational network system 300 including an educational social network/collection component 302. The educational social network component 302 employs, for example, an educational social network having the organizational structure illustrated and has some similar aspects to the educational social collection component 110 of FIG. 1. The educational social network system 300 is organized into categories stored in a data store and that are provided with various component, including, for example, a social activity category operable by a social activity component 304, and an educational activity category that is operable by an educational activity component 306. Each of the categories is subdivided into general categories corresponding to social activity information and also corresponding to educational activity information. The different categories of information are then provided in a network for presenting, interfacing with and viewing by a student, teacher, staff member, parent or other user.

For example, the social activity component 304 provides various different categories including a public interface component 310, a personal offices component 320 and communication tools component 330, which operate to provide categorical data to users of the system. The public interface 310 provides different sub-categorical components related to publicly available information, such as a news announcement component 311, which provides, presents or displays various activities, events, happenings, information, achievements, facts, etc. pertaining to the academic institution and tools for interfacing with the data within a new announcement interface, for example. Other sub-categorical components provided by the public interface 310 include school presentation component 312 that displays presentations that relate to the school in general, class presentation component 313 that displays presentations from various classes of the school, a community presentation component 314 that presents information related to school groups (e.g., Spanish club, parent teacher organizations, or any other group or club for students, teachers, and/or parents), blog presentation component 315 that provides school blogs and a contest presentation component 316 that provides, presents or displays contests offerings at the school and information related (e.g., rules, entries information, applications, etc.) in a contest presentation interface, for example. School presentations 312, for example, comprise slides, talks, speakers, sports rallies, and any other presentation endorsed specifically by administration and the school or institution in general that may be displayed in school presentation interface. Class presentations 313, for example, comprise individual classroom presentations that are provided for public view, such as teacher discussions, exemplary student presentations, and classroom content to be presented with the public interface component 310 in a public interface. Community presentations 314, for example, includes various groups or group forums for view by the public or other community activities that are held at the school premise or sponsored specifically by the school in order to inform people or user's of the system publicly. Blog presentations 315, for example, provide for blog activity and a forum that enables public blogging related to school activities. Contest presentations 316, for example, include various contest events, entries, results, etc., of school contests that may be displayed in contest presentation interface, for example.

The personal office component 320 includes personal office interfaces with students, teachers, faculty and parents. The personal office component 320 includes sub-categorical components such as a student office component 321, a teacher office component 322, a principal office component 323 and a parent office 324. Each of these components render interfaces for the school and generate/provide communication tools discussed herein for communication with different individuals or groups, which is further discussed in detail infra.

The student office 321, for example, operates to provide student office data from a data store or memory and can include information on student individual work, as well as results of student collaborative work. In addition, public information pertaining to student life in general could be provided, such as student question and answer session from outside or potential students with current students, various communication tools further detail below, as well as student class representatives and elected student official activities. The teacher office 322, for example, provides teacher material and data, such as the names, profiles, histories, activities, credentials and other teacher data pertaining to the different teachers at the institutional academy. Other data and tools for communicatively interfacing with the teacher office 322 component could also be provided and are not limited to any one example. The principal office component 323, for example, provides for data about general principal activities and information related to administrative faculties, the school overall, teachers, students, parents, organizations or community activities at the school. The principal office component 323 may also operate as a school principal interface that provides school information related to a principal or other faculty member of a school. A parent office 324 component, for example, provides for information, communication tools and otherwise parent related data such as field trip information, or other information related to students requiring parents to be informed of or participate in. While each of the components above provide for data stored within a data store, these components also provide for communication tools 330 to be utilized within the context of each category or from the overall system to enable participation on the network with parent, teacher, student and administrative input.

For example, communication tools component 330 provides for various communication tools, which include networking resources in order to provide an interactive experience and forum for the school body (e.g., staff, faculty, students, parents, etc.). According to the learning objectives of the school, communication tools are provided such as a message exchange tool 331, in which to interchange communication. Comment sections, email exchanges, contact information, chat dialogs, search engines, etc. are provided by the message exchange tool 331 and provided to each of the categories discussed above for the respective components of the network. A blogs tool 332, for example, enables individuals to blog about various topics and present topics for discussion strings to develop. Various tools, such as the blog tool 332, can be secured for use and only enable operation if a level of authorization is provided to a user. For example, an authorized level could be provided by a teacher or other school official. The blog tool 332 therefore enables an organized communication between adults: teachers and their colleague teachers, teachers and parents, etc. A contest tool 332 component, for example, provides various mechanisms to interact, view and present activities related to contests offered at the school. An application for entry, commentary section, entry presentations, research, and contest details for the contestants or potential contestants, etc., for example, are included. The project line tool 334 also can provide similar functions and tools for projects.

Each of the tools 330 provided can be restricted to a minimum of only that needed to meet the objectives of the educational social network component. Alternatively, each of the tools discussed are provided to each category of the educational social network system 300 for various component objectives. For example, using the available mechanisms of the social network (media content and tools), the educational-social network puts the various tools in the context of solving educational problems and tasks of training communication. The goals include: (1) the formation of universal common educational network skills: information search and allocation, as well as information exchange, correction, and presentation; (2) the formation of communicative network skills of group activity during thematic communication, where communication is viewed as collaboration: distributing social roles and retaining one's own social role, readiness for changing social roles, the ability to adhere to collective decisions; (3) the formation of communicative network skills during the comparative analysis of the results of one's own thematic activity and that of others, where communication is understood as interaction: a democratic discussion of the “products” of one's own learning activity and that of others; the adequate self-assessment and the substantiated assessment of the work of others; justified and accountable voting; and (4) the formation of individual cognitive motives and individual needs for thematic network communication (i.e., communication built around solutions for educational problems and social problems within a specific subject area).

The communication tools 330 discussed are also configured to operate with categories operated by components of the educational activity component 306, which task shares with additional component according to various categories that are further sub-divided into sub-categories. For example, the educational activity component 306 presents or displays activities related to the school, communicates with the social activity component and presents/displays educational task or activities involving the social activity component 304. For example, students could be assigned to search information in a search engine for research and provided comments at a comment section at the teacher's office. Other interactions with the social activity component 304 including the categories and sub-categories discussed above are also envisioned.

The educational activity component 306 is communicatively coupled to categories including communities component 340, contests component 350, projects component 360 and portfolio component 370 that respectively include a start up page 341, 351, 361 and general data 371 to provide general profile information about the activities of each category. For example, the communities component 340 includes a startup page component 341 that generates or displays information stored in a data store pertaining to particular communities, such as language club, art club, drama club, or other school organizations sponsored by the school. In one exemplary aspect of an embodiment, the educational activity component 306 determines educational activities via the network system education activities from communications with the communities component 340, contests component 350, and projects component 360 in order to send output from the educational activities determined to the portfolio component 370. For example, as various school activities (e.g., entry, presentations, contest rules, etc.) are posted to the contests component 350 and displayed thereat, the educational activity component 306 can determine these educational activities as they relate to each student and provide them to each students portfolio generated or provided by the portfolio component 370.

The communities component 340, the contest component 350, and the projects component 360 each correspond to various activities of students relating to organizational groups, contests and projects that students are involved with. The components respectively include an assessment tool 345, 353 and 367 and an export mechanism 346, 353 and 368. The assessment tools 345, 353 and 367, for example, operate to enable grades or rankings to be given to individual projects, contests, communities that can be provided by teachers, faculty and/or students to grade other students. For example, students can vote and rate one another's quality of participation in educational and social activities with a voting mechanism or assessment tool. In addition, the export mechanisms 346, 353, 368 generate data as output and exports the output to the portfolio component 370, which is configured to associate the student activity information in portfolios for each student. The export mechanisms select data within each of the components and exports the data selected to the portfolios of each student.

The communities component 340 further provides the startup page 341, a file exchange mechanism 342 for uploading, downloading or exchanging files, a community presentation component 343, and a line exchange 344. The community presentation component 343, for example, allows for presentation to be provided by different communities at the school. The line exchange 344 enables direct interaction through the use of reply messages in various communication forums.

The contests component 350 further includes a contest entry component 351 that provides contest entries as well as any submissions to contests, which can be rated with the assessment tool 353. The projects component 360 further includes a group/role creation component 362 configured to enable groups to be selected and roles to be assigned or created. The group/role creation component is configured to facilitate selections and corresponding roles to members of the project group for a project. A project presentation component 363 is configured to present presentations that can be designed with tools from presentation templates 365 in a project presentation itneface of the system. A repository 364 enables students to further exchange information with one another, and enable students to accumulate skills of operating network tools and include the educational social network into a broad context of internet networking capabilities.

The student portfolio component 370 generates portfolios stored in a data store for each student among the plurality of students attending the school, potentially attending the school, and/or alumni whom have already graduated the educational institution. Each portfolio 370 generated by the portfolio component 370 is organized according to various data received from the export mechanisms 346, 353, 368 for the different components. The general data component 371 can provide photo, fingerprint, identification, general background information, personal information, etc. to be presented about a student, teacher or staff member. An achievements component 372 provides various achievements throughout an academic career, which can include information on student individual work, as well as results of student collaborative work. A development component 373 provides development related to the student of the portfolio, such as progress in various subjects, strengths, goals for growth, development indicators, references, comments from teachers, etc. A reader pass component 374 can provide for passing grades, passes to areas of the school such as the library or other facilities, and log information regarding each area.

The educational social network component 302 of the system 300 generates a network that links students, teachers and administrative personal in both an educational and social manner and generates and stores information about a student's educational and social activities. The educational social network can be situated on one or more server computers that can communicate with devices of students, teachers and/or administrators over a network via cloud computing. Students can employ educational social network to share information regarding educational and social activities, such as participation in projects and competitions. Students and teachers can also share educational information, comments on one another's educational and social activities, join social and/or educational groups, suggest events and activities to attend, and etc. Students can employ educational and social network to collaborate on ideas and projects and receive answers to question, participate in a discussion forum, participate in a real-time streaming seminar or interactive discussion, and etc. Not only can students, share messages with other students and teachers via the educational and social network 230, students can vote and rate one another's quality of participation in educational and social activities. Students and teachers can further form online communities with the educational and social network

In an embodiment, the component 302 of system 300 automatically receives information from the educational activity component 306 and social activity component 304 related to participation in network competitions and projects. In particular, the educational social network component 302 can receive both quantitative data about a student's participation in various projects, competitions, olympiads, and etc., held with the help of the educational-social network, and qualitative indicators of the student's progress as the result of these events (i.e. what the student has scored following the voting results associated with the educational and social activities held on the educational and social network).

In addition to these quantitative and qualitative indicators, the component 302 can also receive information regarding social activities in all events that are outside the educational social network, yet discussed or revealed through posting and communication via the educational and social network. For example, the educational social network may gather and generate information regarding a student's attendance of coteries, studios, and workshops, which are located both inside and outside an affiliated school, participation in competitions, olympiads, contests, and other events organized outside the educational-social network, visits to museum expositions and temporary exhibitions, theatrical performances, and movies, performances, installations, etc. In an aspect, a student enters all this information in different rubrics of the educational social network. In an aspect, students can supply information under any of the above noted areas to the educational and social network. This information can further be received by component 302 and included in a student's portfolio. As a result, this information is also accounted for in the overall indicators of the school student's social and education activities and improves the rating of his/her portfolio.

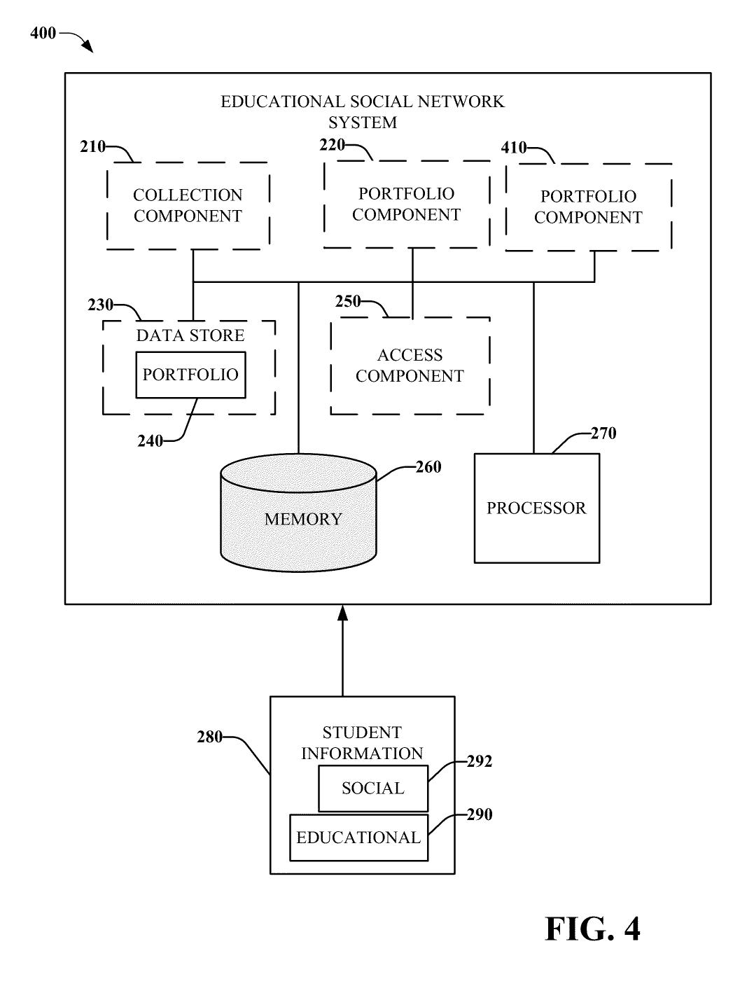

Turning now to FIG. 4, presented is another exemplary non-limiting embodiment of an education social network system 400 in accordance with the subject disclosure. System 400 includes the components of system 200 with the addition of presentation component 410. In an aspect, a presentation component 410 is configured present a community presentation, a contest entry, a project, and a portfolio based on its organization structure. For example, presentation component 410 can present a portfolio based on the various categories the information is separated into. According to this example, a student may desire to view only information regarding grades for a particular class, or information regarding all grades received in classes over the past two years.

In an embodiment, presentation component 410 is configured to present a community presentation, a contest entry, a project, and a portfolio in different manner and with different functionality depending on the viewer based on an access level of the viewer. For example, the presentation component my present a portfolio in a non-editable format to a parent while presenting the portfolio in an editable format to the student for which the portfolio belongs.

In addition, respective devices often have different capabilities and limitations (e.g., screen size, decoders . . . ). In an aspect, the presentation component 410 can provide presentation options in accordance with different device capabilities or limitations. For example, data rendering capabilities may be more limited in a mobile device (e.g., a smart-phone) than in a fixed computing device (e.g., a desktop computer), more effort may be required of a user to consume content such as a video (or other information) from the mobile device than would be required of the user in viewing the same video from a fixed computing device. In addition, because displays of various mobile devices are often smaller than displays in fixed computing devices, it may be possible only to display a relatively small amount of information at any given time on a mobile device. The presentation component 410 can thus optimize display of options and content for respective devices. Finally, data connections between a mobile device and various networked resources (e.g., the Internet) may be slower than corresponding data connections between a fixed computing device and the same networked resources. Accordingly, the presentation component 410 can generate user options to account for variations in device functionality and available bandwidth for consumption and rendering of content. In view of the above, in an aspect, the presentation component 410 can present content in various formats and/or in accordance with various display mediums.

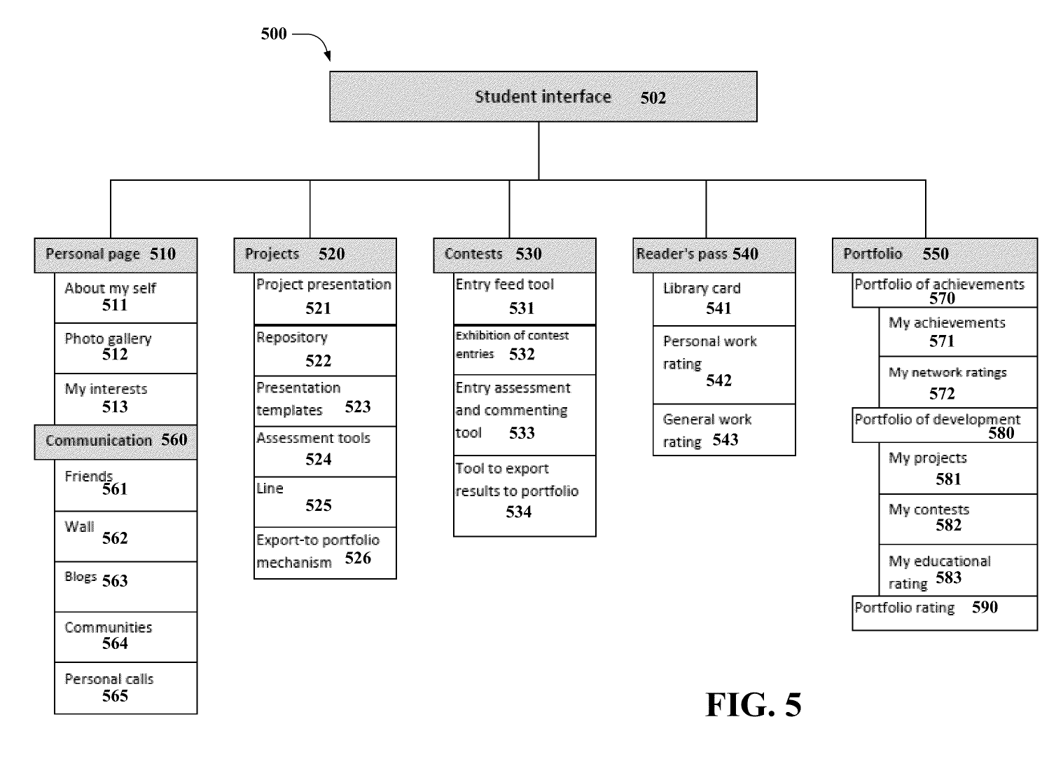

Referring to FIG. 5, illustrated is one aspect of an exemplary embodiment for a student interface system 500. The student interface system 500 includes a student interface component 502 configured to provide or present a student interface such as through the access component 250 of FIG. 2. The student interface component 502 is configured to provide a student interface individualized for each student to interface with the educational-social collection component 210 and the portfolio component 220 for students according to the portfolio of each student and based on a level of authorization for the student. Each student may not have access, for example, to other students most personal information in some embodiments, may have access to some other portfolios or none at all. Certain teachers may also have limited access or access according to a level of authorization granted them from school administrators.

The student interface component 502 generates various configurations of a student according to the student's activity information received, which includes social activity information and educational activity information. The student activity information can be organized into different categories and presented to those users with authorized access, such as the student the information is related to. The student interface component 502, for example, is configured to provide a personal page 510, a project category 520, a contests category 530, a reader's pass 540 category, an individualized portfolio category 550 and a communication category 560. Each category includes sub-categories, which are optionally further sub-divided into additional sub-categories. Each category and sub-category is generated by the student interface component 520 or generated by a specialized component having hardware dedicated to the category and/or software.

In one example, the student interface component 502 is configured to present a student personal page 510 having profile information personalized to each individual student. For example, one section of the personal page 510 includes an “About myself” category 511, which includes any information, illustration or graphic pertaining to an individual student. The personal page 510 further includes a photo gallery 512 of personalized digital photos, and a “My interests” category 513 having additional information that is personal to the student.

In another exemplary embodiment, the student interface component 502 is configured to provide the projects category 520 that further provides project presentations 521 for each student. Presentations generated by the student are posted, edited, presented and displayed according to settings at the project presentation category 521, which may be set by the student. For example, some presentations, which may be considered by the student to be his/her best presentations, could be selected or set by the student to be viewed by different groups of viewers, such as teachers, other students, parents, colleges, friends, etc. Other settings could also be implemented here and in other categories discussed herein. The projects category 520 further includes a repository 522, which is operable as an archive or other storage that houses presentations of students, older and newer versions of presentations, communication media, conversations, contests entries, homework, assignments, and any other school activity that the student can use to aid in or supplement school related projects. A presentation template category 523 further provides templates for presentations to be created and edited, such as older presentations, various themes, fonts, flow diagram tools, clip art, and the like tools. An assessment tools 524 further enables presentations to be assessed by teachers, the student, other students and the like. Comments could be provided in addition to a rating mechanism or a vote mechanism that is rendered in order to evaluate a students presentation. A line category 525 further enables messages in the form of text, chat, messages, etc. to be exchanged with the student at the interface 502. An export-to portfolio mechanism 526 is configured to transmit or submit presentations to the students portfolio or other file where the presentations can then be associated to the students portfolio or uploaded from another source or from a memory to the portfolio.

The contests category 530 includes an entry feed tool 531 that enables contest entries to be submitted or posted for entry. For example, the student could view the entry feed tool 531 to observe past, current and future contest scheduled, as well as provided feedback exchanges related thereto. An exhibition of context entry 532 provides a the contest entries for exhibition at the student interface component 502. An entry assessment and commenting tool 533 enables contest entries to be assessed or rated with a ratings mechanism or voting tool by teachers, the student, other students and the like, as well as commentary for evaluating a contest entry. An export-to portfolio mechanism 534 is configured to transmit or submit presentations to the students portfolio or other file where the contest entries can then be associated to the students portfolio or uploaded from another source or from a memory to the portfolio.

The reader's pass category 540 includes a library card 541 that provides a level of access to books or a library center online or offline at a facility. Due dates, fines, books/media on loan, etc. are associated and categorized with the library card 541. Personal work rating 542 is configured to define the student's grades, pass or fail, progress or other levels of assessment as related to research, assignments, or other student activities from the social component and educational component. The student can provide self-evaluations or assessments in this category, for example. Additionally, a general work rating 543 enables general activities and school product generated by the student activities to be rated. The general ratings may be from general school progress evaluated by teachers, for example.

The portfolio component 550 further includes a personalized portfolio of activities, such as achievements in a portfolio of achievements 570 having personal achievements in a “My achievements” category 571, and ratings in a “My network ratings” category 572 from others. Projects, contests entries, and assessments of work from educational activities and social activities assigned with a social activity component of the network systems herein are received from exporting mechanisms at a portfolio of development category 580 and a portfolio rating category 590. A “My projects” category 581, a “My contest” category 582 and a “My educational rating” category 583 are provided to generate and organize the various student activity information received, for example.

The communication component 560 is configured to provided the tools for media and media content generation at the student interface component 502. A friends section 561 for connecting with, providing to and otherwise interchanging with selected individuals (teachers, students, etc.) is generated by the communication component 560, for example. A wall tool 562, a blogs tool 563, communities tool 564, and personal calls tool 565 for messages is also provided herein.

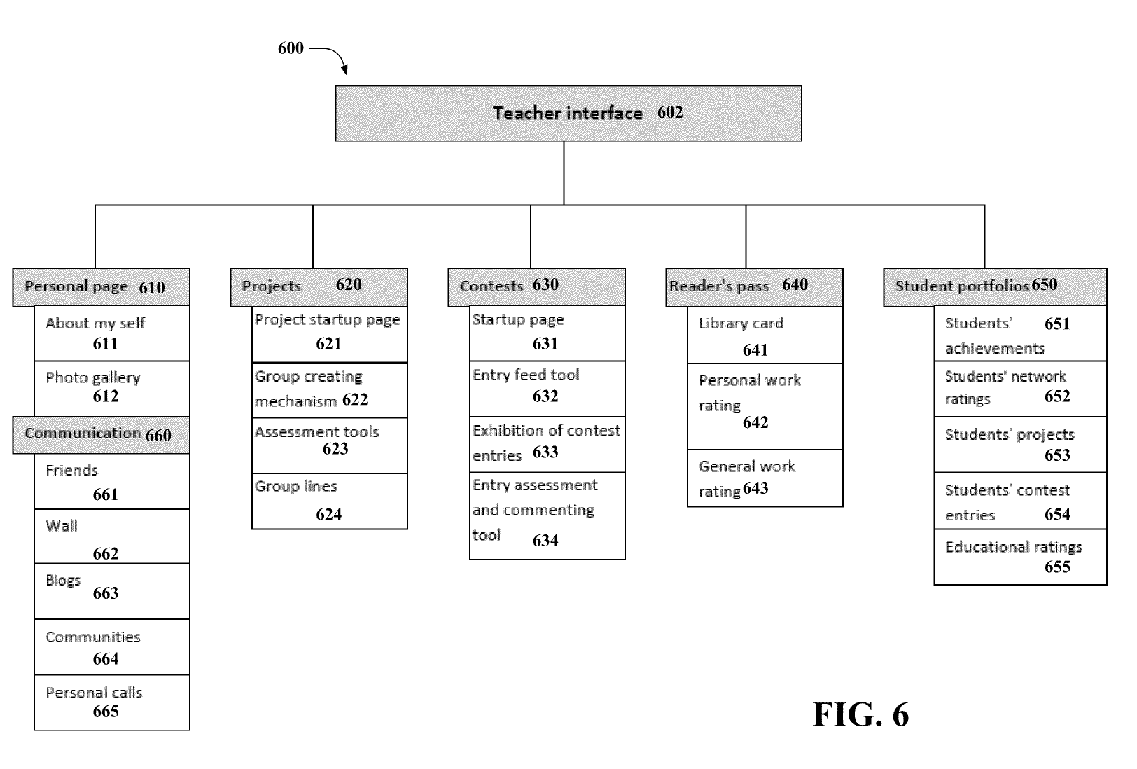

Similar to the student interface component 502 discussed above in relation to FIG. 5, FIG. 6 illustrates a teacher interface component 602 of a teacher interface system 600 that presents teacher information for a teacher. The components or categories discussed in relation to the student interface above are similar in relation to the teacher interface and equally apply to the teacher interface component 602 in function and configuration.

The personal page component 610 includes an “About my self” category 611, for example, and a photo gallery 612. A projects component 620 provides a project start up page 621 that operates as a home page or general information forum for projects that the teacher may provide or design to present to the students via the student interface component discussed above. A group creating mechanism 623 enables teachers to assign, create and present project groups certain roles, members and responsibilities. An assessment tools 623 enables the teacher to assess students according to social activities, educational activities and work product related to the school or classroom activities. A group lines category 624 provides the ability for groups to communicate with the teacher and one another through message replies, etc. A contest component 630 includes a start up page 631, an entry feed tool 632 for receiving and accepting contest entries, an exhibition of contest entries 633, and an entry assessment and commenting tool 634. A reader's pass component 640 provides a library card 641 category, personal work rating category 642, and a general work rating category 643. A student portfolios component 650 provides a students' achievements category 651, a students' network ratings category 652, a students' projects category 653, a students' contest entries category 654 and educational ratings category 655, which enable the teacher to interface, rate and evaluate students' work products.

The communication component 660 is configured to provided the tools for media and media content generation at the teacher interface component 602. A friends section 661 for connecting with, providing to and otherwise interchanging with selected individuals (teachers, students, etc.) is generated by the communication component 660, for example. A wall tool 662, a blogs tool 663, communities tool 664, and personal calls tool 665 for messages is also provided herein. The teacher is able to provide various levels of authorization to the various tools to various students depending upon their privileges.

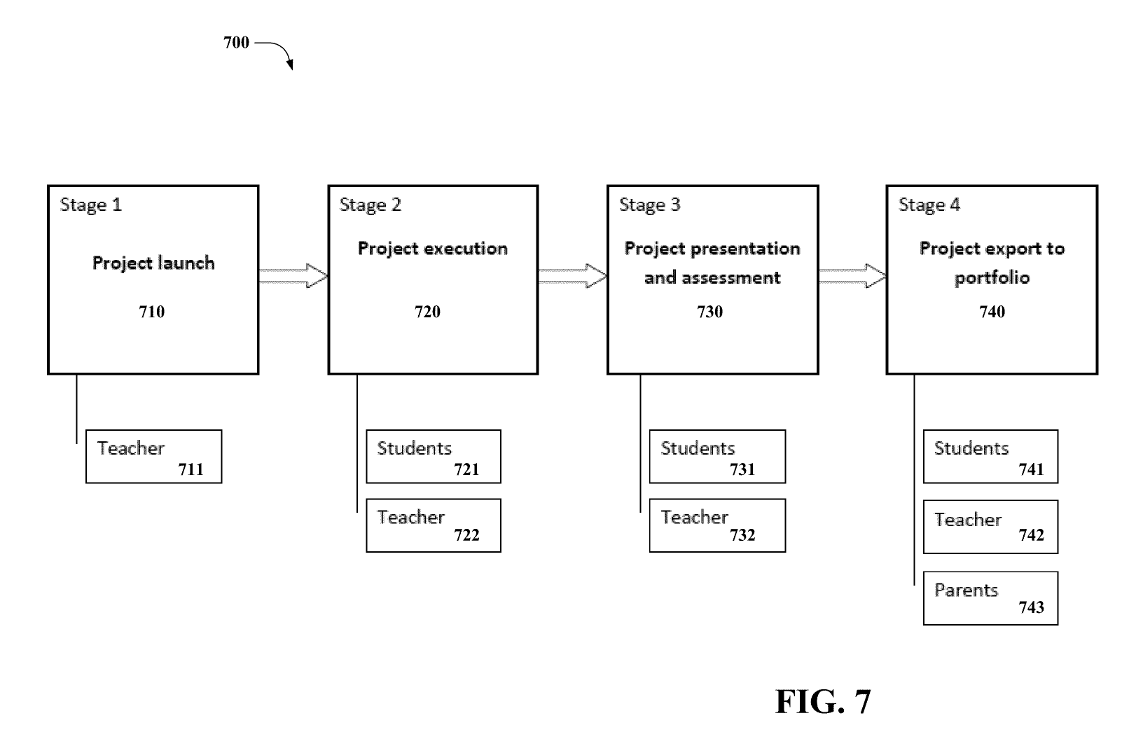

Looking now to FIG. 7, presented is another exemplary non-limiting embodiment of an education social network system 700 in accordance with an aspect of the subject disclosure. System 700 includes communication links and processes associated with the components of system 100 and 300 from FIGS. 1 and 3, for example. As discussed supra, a projects component 360 provides for educational projects via the educational activity component 306 and also is configured to provide for social projects via the social activity component 304. For example, social activities such as searching, finding, linking to, communicating with friends or other on the education social network system may be assigned that coincide with stated objectives for a class assignment and then evaluated. Projects component 360 may provide thus for both social and educational projects assigned to groups or students individually. The system 700 illustrates implementation stages and participants able to interface with the progress at the various stages.

At stage 1 a project launch 710 is illustrated where a project is launched via a teacher 711, such as via the teacher interface discussed above. The outlines, procedures, objectives, tools, etc. could be provided and guidance to students and their groups for completing the project, such as via student interfaces connecting students to the network system. At stage 2, a project execution 720 is processed to students 721 with the teacher 722 where initialization, processing and completion of various stages of the project are implemented, such as with questioning, dialoging, role providing, and other interactions for progress. At stage 3, project presentation and assessments are implemented with the educational social networking system as between students 731 and teachers 732. At stage 4, projects are exported to individual portfolios, in which students 741, teacher(s) 742 and parents 743 via parent interfaces or other interfaces are able to view, participate, and/or interact with the project.

The project components disclosed herein are configured to organize, display and provide projects at the school in the educational-social network as an important source of information about students' out-of-school activities and an opportunity to see how students master: (1) various network tools and (2) various social roles within joint group activities. For example, network tools, as discussed above, can include line tools for information handling skills, repository tools, project presentation and creating tools, and voting techniques for a scoring system.

The line tools 367 discussed above can include the thematic information of project contents proper and correspondence between project participants as the project progresses. This work contributes to the formation of very complex skills in school students of exchanging simultaneously thematic information between several participants in a common cause, namely, the skill of addressing a specific project participant to whom one has questions or to whom one has to report with simultaneous understanding that one's message is also viewed by other members of the work group; the skill of viewing periodically the whole line component 367 of messages and selecting information that is addressed to a specific project participant; the skill of formulating clear questions and answers to which contribute to project progress; the skill of issuing specific commissions or assignments whose implementation contributes to project progress; the skill of adequately stating the scope performed and commenting on the work done.

All participants put all thematic information that constitutes the project contents in the repository tools 364 for the project. In one example of a learning implementation, the repository 364 provides no opportunity for creating folders whose names (e.g., the last names or social roles of project participants) would simplify information exchange between school students, school students have to master a whole set of special network skills related to group communication. Among these skills are the skill to create a precise and vocal name to one's files (so that other group participants could easily orient themselves in the materials by file names), the skill to designate various versions of a file that exists under the same name, for example, to indicate either the successive number of the file next to its name, or the date and exact time of its creation, or any editing marks understandable to the other members of the group, etc. Both the line tools 367, exchange tools 331 and the repository tools 362 enable information handling skills and contribute to the formation of the culture of a thematic communication.

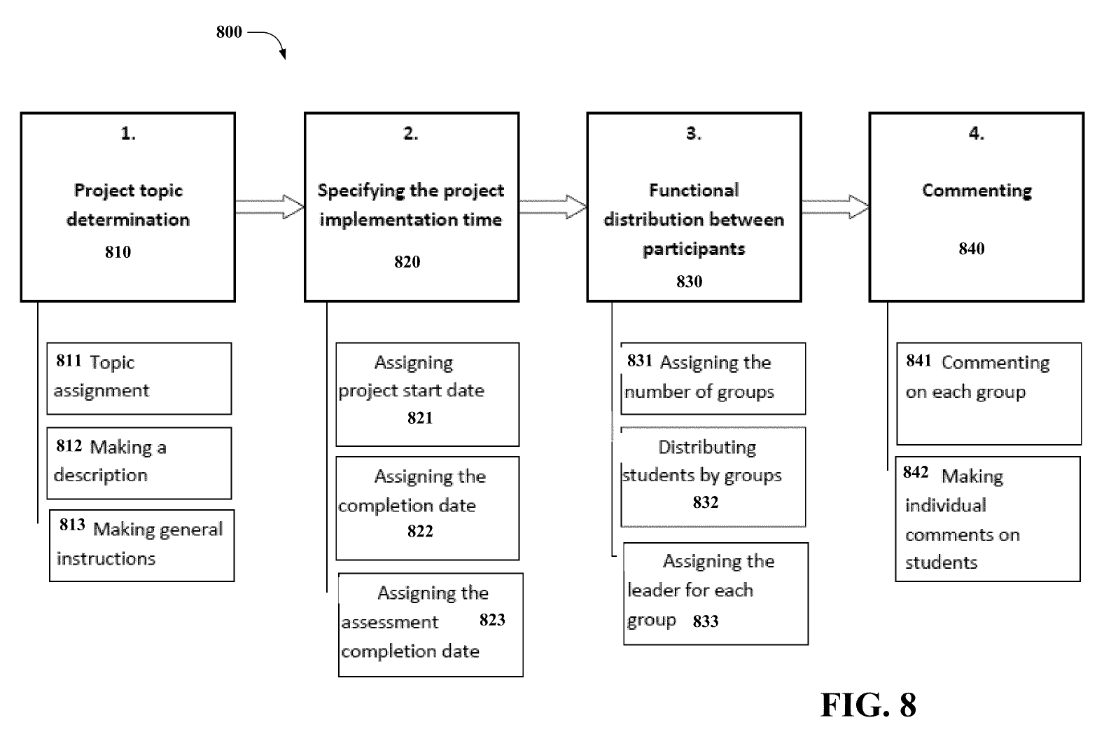

Referring now to FIG. 8, illustrated is an aspect of a project component 800 configured to provide a project launch stage (e.g., project launch 710). For example, the project component 800 comprises a project topic determination component 810, a specifying the project implementation time tool 820, a functional distribution between participant component 830 and a commenting tool 840. The project topic determination component 810 includes a topic assignment tool 811, a description making tool 812, and a general instructions making tool, in which the initial launch of projects is provided by the teacher at the teacher interface to the educational social network systems herein. The specifying the project implementation time tool 820 includes a project start date assignment mechanism 821, a completion date assignment mechanism 822, and an assessment completion date mechanism 823. The functional distribution between participants component 830 includes a group number assignment mechanism 831, a student group distribution tool 832 and a group leader assignment tool 833. The commenting component 840 includes a group commenting tool 841 and an individual commenting tool 842.

Mastering various social roles within joint activities in each group that contributes to a project includes the role of a project leader (the teacher defines this role with the leader assignment tool 833, appointing one of the school students the project leader in each group that works on a project) and the roles of rank-and-file project members, which the leader, appointed by the teacher, distributes in his/her group. The project leader formulates the project goal and objectives, gives specific assignments to each member of the group, and, after the group has finished gathering and writing specific materials, creates the already prepared presentation from his/her material, both textual and illustrative. The roles assigned by the leader, for example, are a text creator (who compiles commentaries on the ready/found/texts or illustrations, as well as independently shot materials; writes the necessary texts; compiles texts found by the search engine), the searcher (who searches for the right texts and illustrations), the editor (who edits both texts and text illustrations), and the photographer-designer (who makes the necessary photographs and helps the leader to finalize the project by offering his/her model of the future presentation). All educational-social roles of project participants are recorded by the system: the teacher appoints leaders for each group that works on a project, and each leader distributes the roles between rank-and-file project participants, entering their logins-passwords into the dropdown list of these roles. Thus, each project participant performs an educational-social role, assigned to him/her and recorded by the system, and the designation of this role at the last stage of the project life (after the project has been presented to the public and assessed as the result of general voting) is saved and attached to the project copy that is sent to the portfolio of each project participant.

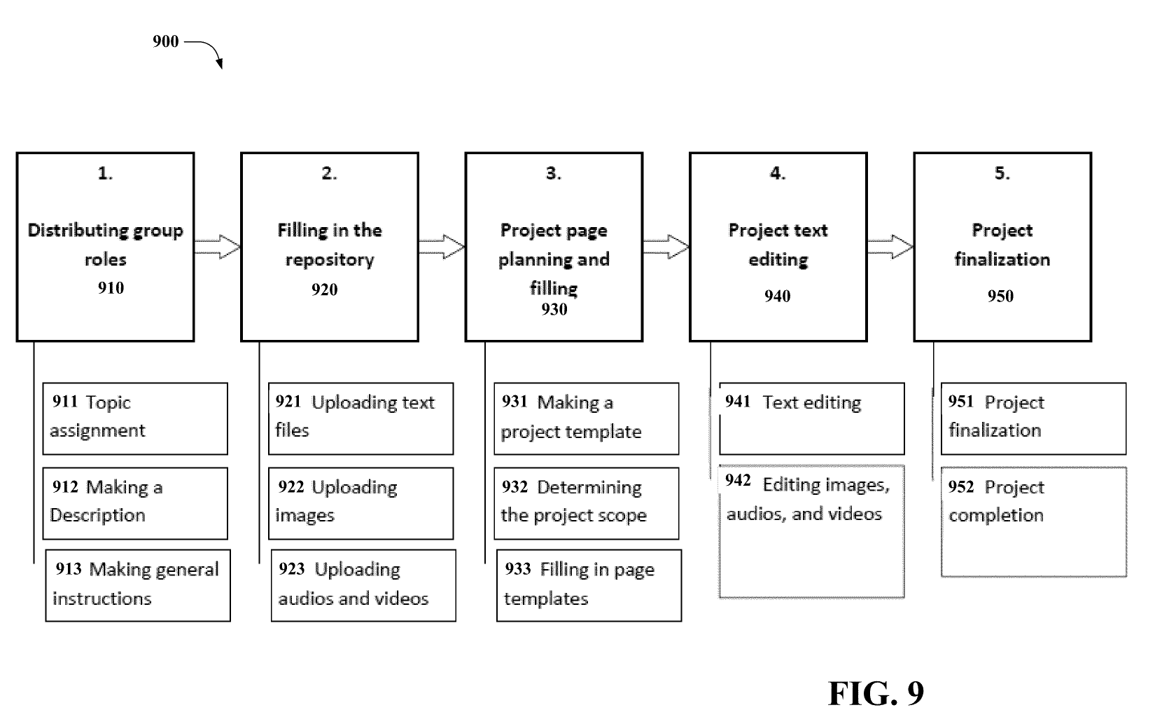

Referring now to FIG. 9, illustrated is an aspect of a project component 900 that is configured to create and present a project. This skill is very important for contemporary school students because presentations are becoming an increasingly popular form of information representation. In order to form this skill, not simply as a technical, but as a skill closely related to web design culture, students master a series of cultural images—templates, which are accompanied by short and specific commentaries. Both presentation samples and commentaries provided the students are dedicated to the general web design requirements: slide structure requirements (if a slide is mainly textual or mainly illustrative, or if a slide balances text and illustrations); the possible color palette of the main background and plate colors; the competent use of fonts in the main text and in headlines, as well as the color and size of the fonts of the main and additional texts; the necessity to create and maintain the general style of a representation. The proposed system allows school students not only to use the samples provided—presentation templates, but also to create new presentation templates themselves, relying on the collection of individual elements (color palettes, font sets and sizes, design elements).

In one example, a project component 900 is configured to operate a project execution stage with a group role distributing component 910, a repository filing component 920, a project page planning and filing component 930, a project text editing component 940, and a project finalization component 950. The group role distributing component 910 includes a topic assignment tool 911, a description making tool 912, and a general instruction making tool 913. The repository filing component 920 includes a text file uploading tool 921, an image uploading tool, an audio and video uploading tool 923. The project page planning and filing component 930 includes a project template making tool 931, a project scope determining tool 932, and a page template filling tool 933. The project text editing component 940 includes a text editing tool 941 and an image, audio, and video editing tool 942. The project finalization component 950 includes a project finalization tool 951 and a project completion tool 952.

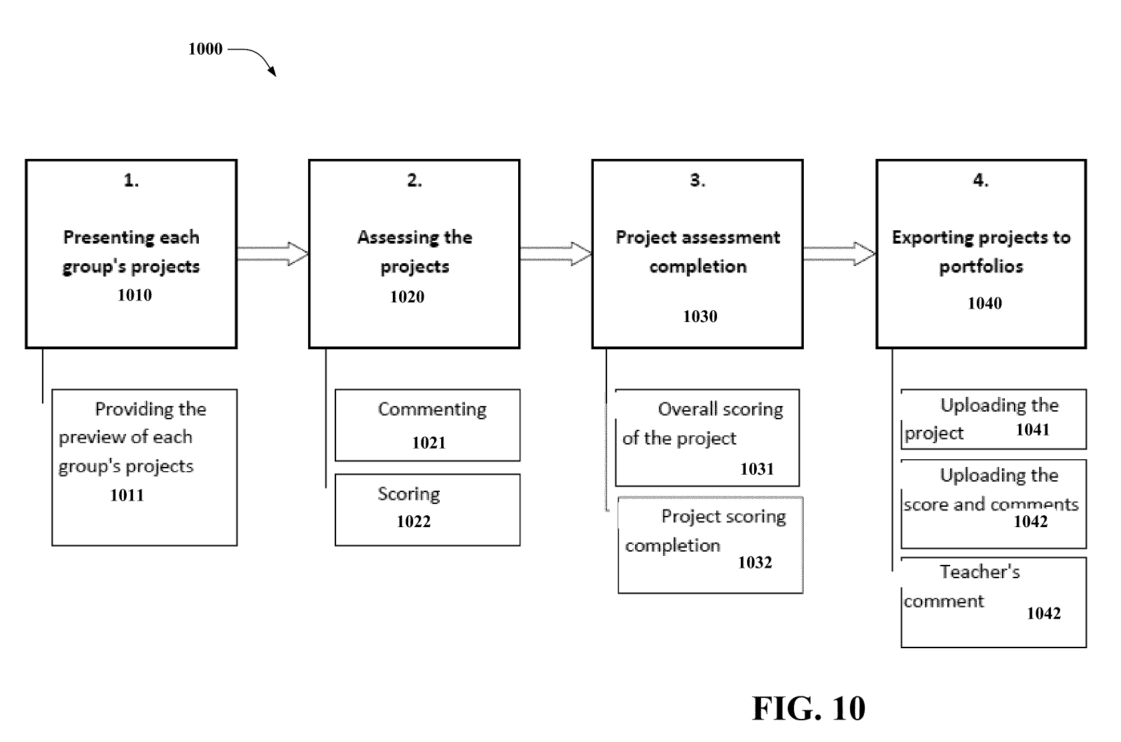

Referring now to FIG. 10, illustrated is an aspect of a project component 1000 that is configured to present, assess and export a project. With the various components students are able to master voting techniques within the proposed scoring system. The social educational essence of mastering the voting techniques is that, when voting, school students (a) can see all grades given for this work by the other school students, which teaches them to display consideration and caution when pronouncing their own judgments, and (b) have to allot their grades publicly, that is, indicating their last names and commenting on their grades, which teaches school students to bear responsibility for the grades they give. If publicity requirements are ignored, for example, the system will not accept the grades allotted by school students. Thus, mastering the voting techniques, school students learn to assess objectively the results of the activities of others, to make measured value judgments, and to bear responsibility for them.

In one example, an aspect of a project component 1000 is configured to operate a project presentation, assessment and exportation stage with a group project presentation component 1010, an assessment component 1020, a project assessment completion component 1030 and an exporting project component 1040 for exporting projects to a student portfolio. The group project presentation component 1010 includes a preview tool 1011 for each group's projects. The assessment component 1020 includes a commenting tool 1021 and a scoring tool 1022. The project assessment completion component 1030 includes an overall scoring component 1031 for the project and a project scoring tool 1032 for completion of the project. The exporting project component 1040 includes an uploading tool 1041 for the project, an uploading score and comment tool 1042 and a teacher comment tool 1042.

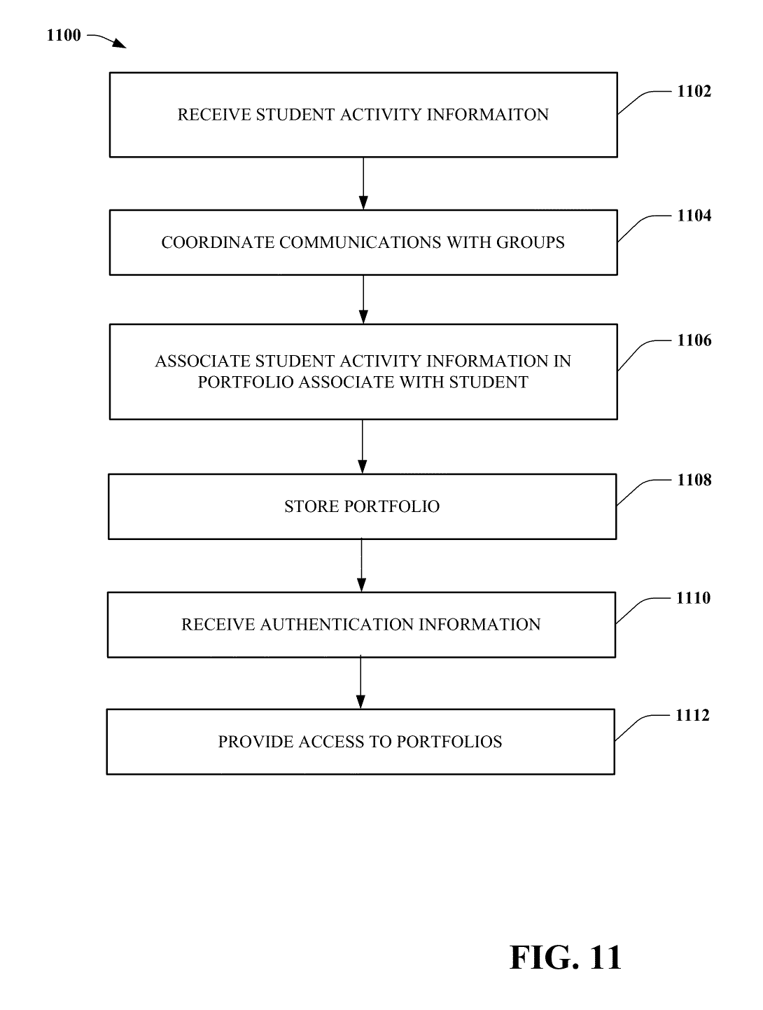

FIG. 11 illustrates a methodology or flow diagram in accordance with certain aspects of this disclosure. While, for purposes of simplicity of explanation, the methodologies are shown and described as a series of acts, the disclosed subject matter is not limited by the order of acts, as some acts may occur in different orders and/or concurrently with other acts from that shown and described herein. For example, those skilled in the art will understand and appreciate that a methodology can alternatively be represented as a series of interrelated states or events, such as in a state diagram. Moreover, not all illustrated acts may be required to implement a methodology in accordance with the disclosed subject matter. Additionally, it is to be appreciated that the methodologies disclosed in this disclosure are capable of being stored on an article of manufacture to facilitate transporting and transferring such methodologies to computers or other computing devices. The term article of manufacture, as used in this disclosure, is intended to encompass a computer program accessible from any computer-readable device or storage media.

Referring now to FIG. 11, presented is a flow diagram of an example application of systems disclosed in this description accordance with an embodiment. In an aspect, exemplary methodology 1100 of an educational social networking system is stored in a memory and utilizes a processor to execute computer executable instructions to perform functions. At 1102, student activity information associated with a student is received, including at least educational activity information and social activity information for a plurality of students. Further, in an aspect, the information is received from an external electronic source, such as an interactive electronic application, over a network, in response to receipt of the information by the external electronic source. The information associated with the student may be presented or displayed to the network and include a social level of participation in a social activity, a community level of participation a contest level of participation in a competition or contest, and a project level of participation in a project. The information may be presented in portfolios, for example, belonging to respective students.

At 1104, communications are coordinated with community groups, contest groups, project groups and a social group. The social group includes the plurality of students at the school, teachers and parents that are able to interface with the public aspects of the system. Communications among these groups are facilitated by communication tools rendered, for example, and organized to be provided on the network.

At 1106, the information is associated in a portfolio for the student. At 1108, the portfolio is stored in a data store. It should be appreciated that the portfolio can remain stored in the data store or be previously stored in the data store prior to the association of the information therein. At 1110, a level of authorization is determined based on authentication information received from at least one student of the plurality of students, and at 1112 access to respective portfolios is provided based on the level of authorization determined (e.g., no access, complete access or partial access to some, but not all components, structure or categories of the network).

In one embodiment, providing the student activity information includes providing a social level of participation in a social activity, a community level of participation, a contest level of participation in a competition, and a project level of participation. Each level includes at least one of no participation, complete participation, or partial participation, in which corresponding roles or participating activity are presented.

### Example Operating Environments

The systems and processes described below can be embodied within hardware, such as a single integrated circuit (IC) chip, multiple ICs, an application specific integrated circuit (ASIC), or the like. Further, the order in which some or all of the process blocks appear in each process should not be deemed limiting. Rather, it should be understood that some of the process blocks can be executed in a variety of orders, not all of which may be explicitly illustrated in this disclosure.

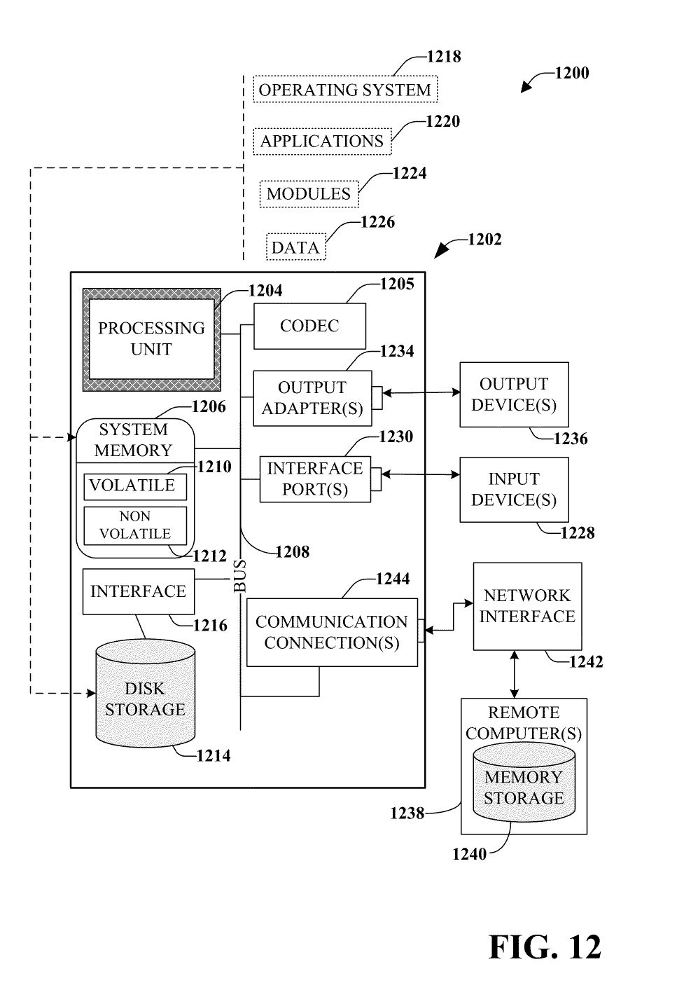

With reference to FIG. 12, a suitable environment 1200 for implementing various aspects of the claimed subject matter includes a computer 1202. The computer 1202 includes a processing unit 1204, a system memory 1206, a codec 1205, and a system bus 1208. The system bus 1208 couples system components including, but not limited to, the system memory 1206 to the processing unit 1204. The processing unit 1204 can be any of various available processors. Dual microprocessors and other multiprocessor architectures also can be employed as the processing unit 1204.

The system bus 1208 can be any of several types of bus structure(s) including the memory bus or memory controller, a peripheral bus or external bus, and/or a local bus using any variety of available bus architectures including, but not limited to, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Card Bus, Universal Serial Bus (USB), Advanced Graphics Port (AGP), Personal Computer Memory Card International Association bus (PCMCIA), Firewire (IEEE 1394), and Small Computer Systems Interface (SCSI).

The system memory 1206 includes volatile memory 1210 and non-volatile memory 1212. The basic input/output system (BIOS), containing the basic routines to transfer information between elements within the computer 1202, such as during start-up, is stored in non-volatile memory 1212. In addition, according to present innovations, codec 1205 may include at least one of an encoder or decoder, wherein the at least one of an encoder or decoder may consist of hardware, a combination of hardware and software, or software. Although, codec 1205 is depicted as a separate component, codec 1205 may be contained within non-volatile memory 1212. By way of illustration, and not limitation, non-volatile memory 1212 can include read only memory (ROM), programmable ROM (PROM), electrically programmable ROM (EPROM), electrically erasable programmable ROM (EEPROM), or flash memory. Volatile memory 1210 includes random access memory (RAM), which acts as external cache memory. According to present aspects, the volatile memory may store the write operation retry logic (not shown in FIG. 12) and the like. By way of illustration and not limitation, RAM is available in many forms such as static RAM (SRAM), dynamic RAM (DRAM), synchronous DRAM (SDRAM), double data rate SDRAM (DDR SDRAM), and enhanced SDRAM (ESDRAM.

Computer 1202 may also include removable/non-removable, volatile/non-volatile computer storage medium. FIG. 12 illustrates, for example, disk storage 1214. Disk storage 1214 includes, but is not limited to, devices like a magnetic disk drive, solid state disk (SSD) floppy disk drive, tape drive, Jaz drive, Zip drive, LS-70 drive, flash memory card, or memory stick. In addition, disk storage 1214 can include storage medium separately or in combination with other storage medium including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 1214 to the system bus 1208, a removable or non-removable interface is typically used, such as interface 1216.

It is to be appreciated that FIG. 12 describes software that acts as an intermediary between users and the basic computer resources described in the suitable operating environment 1200. Such software includes an operating system 1218. Operating system 1218, which can be stored on disk storage 1214, acts to control and allocate resources of the computer system 1202. Applications 1220 take advantage of the management of resources by operating system 718 through program modules 1224, and program data 1226, such as the boot/shutdown transaction table and the like, stored either in system memory 1206 or on disk storage 1214. It is to be appreciated that the claimed subject matter can be implemented with various operating systems or combinations of operating systems.

A user enters commands or information into the computer 1202 through input device(s) 1228. Input devices 1228 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 1204 through the system bus 1208 via interface port(s) 1230. Interface port(s) 1230 include, for example, a serial port, a parallel port, a game port, and a universal serial bus (USB). Output device(s) 1236 use some of the same type of ports as input device(s) 1228. Thus, for example, a USB port may be used to provide input to computer 1202 and to output information from computer 1202 to an output device 1236. Output adapter 1234 is provided to illustrate that there are some output devices 1236 like monitors, speakers, and printers, among other output devices 1236, which require special adapters. The output adapters 1234 include, by way of illustration and not limitation, video and sound cards that provide a means of connection between the output device 1236 and the system bus 1208. It should be noted that other devices and/or systems of devices provide both input and output capabilities such as remote computer(s) 1238.

Computer 1202 can operate in a networked environment using logical connections to one or more remote computers, such as remote computer(s) 1238. The remote computer(s) 1238 can be a personal computer, a server, a router, a network PC, a workstation, a microprocessor based appliance, a peer device, a smart phone, a tablet, or other network node, and typically includes many of the elements described relative to computer 1202. For purposes of brevity, only a memory storage device 1240 is illustrated with remote computer(s) 1238. Remote computer(s) 1238 is logically connected to computer 1202 through a network interface 1242 and then connected via communication connection(s) 1244. Network interface 1242 encompasses wire and/or wireless communication networks such as local-area networks (LAN) and wide-area networks (WAN) and cellular networks. LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 1244 refers to the hardware/software employed to connect the network interface 1242 to the bus 1208. While communication connection 1244 is shown for illustrative clarity inside computer 1202, it can also be external to computer 1202. The hardware/software necessary for connection to the network interface 1242 includes, for exemplary purposes only, internal and external technologies such as, modems including regular telephone grade modems, cable modems and DSL modems, ISDN adapters, and wired and wireless Ethernet cards, hubs, and routers.

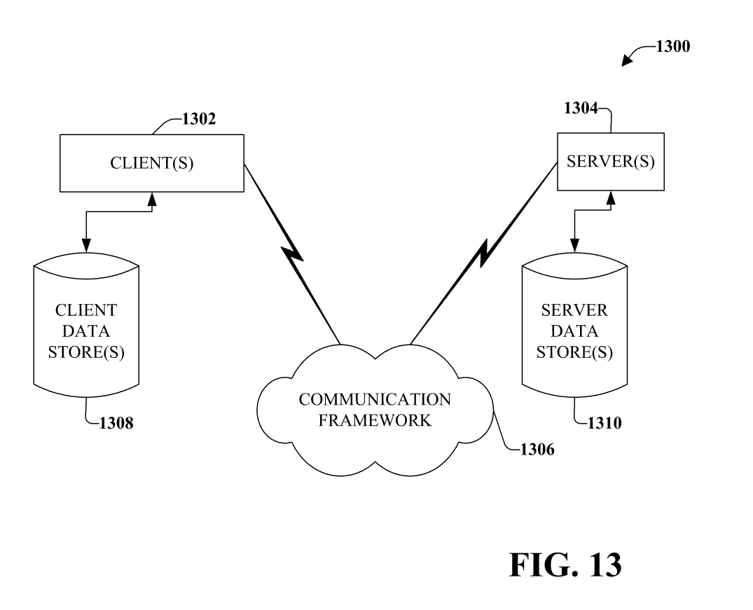

Referring now to FIG. 13, there is illustrated a schematic block diagram of a computing environment 1300 in accordance with this disclosure. The system 1300 includes one or more client(s) 1302 (e.g., laptops, smart phones, PDAs, media players, computers, portable electronic devices, tablets, and the like). The client(s) 1302 can be hardware and/or software (e.g., threads, processes, computing devices). The system 1300 also includes one or more server(s) 1304. The server(s) 1304 can also be hardware or hardware in combination with software (e.g., threads, processes, computing devices). The servers 1304 can house threads to perform transformations by employing aspects of this disclosure, for example. One possible communication between a client 1302 and a server 1304 can be in the form of a data packet transmitted between two or more computer processes wherein the data packet may include video data. The data packet can include metadata, e.g., associated contextual information, for example. The system 1300 includes a communication framework 1306 (e.g., a global communication network such as the Internet, or mobile network(s)) that can be employed to facilitate communications between the client(s) 1302 and the server(s) 1304.

Communications can be facilitated via a wired (including optical fiber) and/or wireless technology. The client(s) 1302 include or are operatively connected to one or more client data store(s) 1308 that can be employed to store information local to the client(s) 1302 (e.g., associated contextual information). Similarly, the server(s) 1304 are operatively include or are operatively connected to one or more server data store(s) 1310 that can be employed to store information local to the servers 1304.

In one embodiment, a client 1302 can transfer an encoded file, in accordance with the disclosed subject matter, to server 1304. Server 1304 can store the file, decode the file, or transmit the file to another client 1302. It is to be appreciated, that a client 1302 can also transfer uncompressed file to a server 1304 and server 1304 can compress the file in accordance with the disclosed subject matter. Likewise, server 1304 can encode video information and transmit the information via communication framework 1306 to one or more clients 1302.

The illustrated aspects of the disclosure may also be practiced in distributed computing environments where certain tasks are performed by remote processing devices that are linked through a communications network. In a distributed computing environment, program modules can be located in both local and remote memory storage devices.

Moreover, it is to be appreciated that various components described in this description can include electrical circuit(s) that can include components and circuitry elements of suitable value in order to implement the embodiments of the subject innovation(s). Furthermore, it can be appreciated that many of the various components can be implemented on one or more integrated circuit (IC) chips. For example, in one embodiment, a set of components can be implemented in a single IC chip. In other embodiments, one or more of respective components are fabricated or implemented on separate IC chips.

What has been described above includes examples of the embodiments of the present invention. It is, of course, not possible to describe every conceivable combination of components or methodologies for purposes of describing the claimed subject matter, but it is to be appreciated that many further combinations and permutations of the subject innovation are possible. Accordingly, the claimed subject matter is intended to embrace all such alterations, modifications, and variations that fall within the spirit and scope of the appended claims. Moreover, the above description of illustrated embodiments of the subject disclosure, including what is described in the Abstract, is not intended to be exhaustive or to limit the disclosed embodiments to the precise forms disclosed. While specific embodiments and examples are described in this disclosure for illustrative purposes, various modifications are possible that are considered within the scope of such embodiments and examples, as those skilled in the relevant art can recognize.

In particular and in regard to the various functions performed by the above described components, devices, circuits, systems and the like, the terms used to describe such components are intended to correspond, unless otherwise indicated, to any component which performs the specified function of the described component (e.g., a functional equivalent), even though not structurally equivalent to the disclosed structure, which performs the function in the disclosure illustrated exemplary aspects of the claimed subject matter. In this regard, it will also be recognized that the innovation includes a system as well as a computer-readable storage medium having computer-executable instructions for performing the acts and/or events of the various methods of the claimed subject matter.

The aforementioned systems/circuits/modules have been described with respect to interaction between several components/blocks. It can be appreciated that such systems/circuits and components/blocks can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components may be combined into a single component providing aggregate functionality or divided into several separate sub-components, and any one or more middle layers, such as a management layer, may be provided to communicatively couple to such sub-components in order to provide integrated functionality. Any components described in this disclosure may also interact with one or more other components not specifically described in this disclosure but known by those of skill in the art.

In addition, while a particular feature of the subject innovation may have been disclosed with respect to only one of several implementations, such feature may be combined with one or more other features of the other implementations as may be desired and advantageous for any given or particular application. Furthermore, to the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

As used in this application, the terms “component,” “module,” “system,” or the like are generally intended to refer to a computer-related entity, either hardware (e.g., a circuit), a combination of hardware and software, software, or an entity related to an operational machine with one or more specific functionalities. For example, a component may be, but is not limited to being, a process running on a processor (e.g., digital signal processor), a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers. Further, a “device” can come in the form of specially designed hardware; generalized hardware made specialized by the execution of software thereon that enables the hardware to perform specific function; software stored on a computer readable storage medium; software transmitted on a computer readable transmission medium; or a combination thereof.

Moreover, the words “example” or “exemplary” are used in this disclosure to mean serving as an example, instance, or illustration. Any aspect or design described in this disclosure as “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Computing devices typically include a variety of media, which can include computer-readable storage media and/or communications media, in which these two terms are used in this description differently from one another as follows. Computer-readable storage media or a computer readable storage medium can be any available storage media that can be accessed by the computer, is typically of a non-transitory nature, and can include both volatile and nonvolatile media, removable and non-removable media. By way of example, and not limitation, computer-readable storage media can be implemented in connection with any method or technology for storage of information such as computer-readable instructions, program modules, structured data, or unstructured data.

The term “computer readable media” as used herein includes computer readable storage media and communication media. Computer-readable storage media can include, but are not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or other tangible and/or non-transitory media which can be used to store desired information. Computer-readable storage media can be accessed by one or more local or remote computing devices, e.g., via access requests, queries or other data retrieval protocols, for a variety of operations with respect to the information stored by the medium.

The term “computer readable media” as used herein includes computer readable storage media and communication media. Computer readable storage media includes volatile and nonvolatile, removable and non-removable media implemented in any method or technology for storage of information such as computer readable instructions or other data. Memory 1018 and storage 1020 are examples of computer readable storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information.

On the other hand, communications media typically embody computer-readable instructions, data structures, program modules or other structured or unstructured data in a data signal that can be transitory such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

In addition to the various embodiments described in this disclosure, it is to be understood that other similar embodiments can be used or modifications and additions can be made to the described embodiment(s) for performing the same or equivalent function of the corresponding embodiment(s) without deviating there from. Still further, multiple processing chips or multiple devices can share the performance of one or more functions described in this disclosure, and similarly, storage can be effected across a plurality of devices. Accordingly, the invention is not to be limited to any single embodiment, but rather can be construed in breadth, spirit and scope in accordance with the appended claims.

What is claimed is:

1. A system, comprising:
at least one processor configured to facilitate execution of one or more computer executable components, the one or more computer executable components, comprising:
an educational-social collection component configured to receive student activity information for a student of a plurality of students, the student activity information including educational activity information and social activity information;
a portfolio component configured to associate the student activity information in a portfolio stored in a data store for the student; and
an access component configured to control access to the portfolio and the educational-social collection component.

2. The system of claim 1, further comprising:
an educational activity component configured to determine educational activities via a network from communications with a communities component, a contest component, a project component, and to send output from the educational activities to the portfolio component; and
a social activity component configured to present a public interface having one or more communication tools and media that receive input relating to social activities and the educational activities provided by the educational activity component,
wherein the educational-social collection component is further configured to receive the educational activity information and the social activity information from the educational activities provided by the educational activity component and the social activities represented in the input to the social activity component.

3. The system of claim 2, wherein the social activity component includes a news announcement interface that displays in a display news and announcements related to a school, a school presentation interface that displays presentations that relate to the school, a class presentation interface that displays presentations from various classes of the school, a community presentation interface that presents information related to school groups, a contest presentation interface that presents contest offered at the school, and a project presentation interface that respectively generates communication and interaction online via the network according to an associated theme.

4. The system of claim 2, wherein the social activity component includes personal office interfaces that include a student interface that presents the portfolio, one or more communication tools, and the student activity information related to the student, and a teacher interface that presents teacher information for a teacher, a school principal interface that displays school information related to a principal of a school, and a parent interface that displays at least a part of the student activity information, wherein the personal office interfaces are respectively configured to provide one or more communication tools to communicate among the personal office interfaces and a user of the system, wherein the one or more communication tools include at least one of a message exchange tool to exchange messages, a blog tool for blogging about topics, a contests tool for communication about a school contest, a wall tool for posting messages and a project line tool for communicating messages.

5. The system of claim 4, wherein the communities component displays various community group forums having activity objectives that are communicated via the contest component configured to organize related contests and the project component configured to organize related projects, wherein the communities component is configured to store the activity objectives within the portfolio component according to the portfolio of each student of the plurality of students, wherein the portfolio component is further configured to organize the portfolio into categories based on features of the information, and to present the portfolio with a presentation component having editing tools for editing the portfolio.

6. The system of claim 5, wherein the communities component, the contest component, and the project component include a search engine, an additional message exchange tool, an assessment tool that includes a voting mechanism and a export mechanism that selects data within each component that is related to each student of the plurality of students and exports the data selected to the portfolio of each student of the plurality of students.

7. The system of claim 6, wherein the contest component displays contest information being offered to members of each community and contest entries corresponding to the contest information, wherein the project component provides a group and role creation mechanism that is configured to facilitate group member selections and corresponding roles to each member for a project, the presentation component configured to present each presentation designed with tools in a presentation template store, and a repository component, wherein the presentation template store includes presentation templates and the repository component includes information to be presented by the presentation component and supports each presentation.

8. The system of claim 7, wherein the access component includes a student interface component configured to render a student interface individualized for each student to interface with the educational-social collection component and the portfolio component for students according to the portfolio of each student and based on a level of authorization for the student, wherein the student interface component is configured to present a student personal profile, communication tools, the student activity information, mechanisms from the project component and the contest component, a rating tool and information relating to the educational activities and the social activities of each student.

9. The system of claim 8, wherein the access component further includes a teacher interface component configured to render a teacher interface individualized for each teacher to interface with the educational-social collection component and the portfolio component for teachers according to the portfolio of each student and based on a teacher level of authorization, wherein the teacher interface component is further configured to present a teacher personal profile, the one or more communication tools, the student activity information, mechanisms from the project component and the contest component, and ratings and library information relating to the educational activities and the social activities of each student.

10. A method for an educational social network system comprising:
receiving, by a computing device including a processor, student activity information associated with a plurality of students, including educational activity information and social activity information that relates to the plurality of students;
coordinating communications with community groups, contest groups, project groups and a social group, wherein the social group includes public communications among the plurality of students, teachers and parents;
associating the student activity information with respective portfolios of the plurality of students;
determining a level of authorization based on authentication information received from at least one student of the plurality of students; and
providing access to the portfolios based on the level of authorization.

11. The method of claim 10, wherein the associating the student activity information includes associating a social level of participation in a social activity, a community level of participation, a contest level of participation in a competition, and a project level of participation in a project in respective portfolios of the plurality of students.

12. The method of claim 11, further comprising:
rendering an announcement interface that provides news and announcements related to a school, a school presentation interface that displays presentations that relate to the school, a class presentation interface that displays presentations from various classes of the school, a community presentation interface that presents information related to school groups, a contest presentation interface that displays contest offered at the school and a project presentation interface that respectively generates communication and interaction online via a network according to an associated theme.

13. The method of claim 12, wherein the rendering the announcement interface, the school presentation interface, the class presentation interface, the contest presentation interface and the project presentation interface includes respectively rendering communication tools that include a message exchange tool, a blog tool, a contests tool, a wall tool, a commentary tool, and a project tool to enable the communication and the interaction, wherein the blog tool includes an authorization component configured to provide blog access according to respective student blog levels of authorization determined for the plurality of students.

14. The method of claim 13, wherein the providing the contest presentation interface and the project presentation interface respectively includes rendering a voting mechanism and a rating mechanism that enables the plurality of students or teachers to vote and rate contest activities and project activities for participating students.

15. The method of claim 10, wherein the student activity information further includes commentary regarding the educational activity information and the social activity information.

16. A computer readable storage medium comprising computer-readable instructions that, in response to execution, cause a computing system to perform operations, comprising:
receiving student activity information associated with a student of a plurality of students, including educational activity information and social activity information, wherein the educational activity information includes community information, contest information, and project information;
associating the student activity information in portfolios respectively associated with the plurality of students;
storing the portfolios in a data store;
determining a level of authorization based on authentication information received from at least one student of the plurality of students; and
providing access to the portfolios respectively based on the level of authorization.

17. The computer readable storage medium of claim 16, the operations further comprising:
rendering a student interface that is individualized according to the student to interface with the community information, the contest information, and the project information based on the level of authorization; and
presenting, in the portfolios, a student personal profile, communication tools, and the student activity information, ratings and information relating to educational and social activities of the student.

18. The computer readable storage medium of claim 17, the operations further comprising:
rendering a teacher interface individualized for each teacher to interface with the community information, the contest information, and the project information according to the portfolios of each of the plurality of students and based on a teacher level of authorization; and
presenting a teacher personal profile, communication tools, the student activity information, rating tools for rating student activities and information relating to educational activities and social activities online of each of the plurality of students.

19. The computer readable storage medium of claim 18, the operations further comprising:
displaying contest information relating to a contest being offered to members of a community group and contest presentation entries corresponding to the contest information;
providing a group and role creation mechanism that is configured to facilitate group member selections and corresponding roles to each member for a project; and
displaying presentations associated with the contest, the project or the community group and with tools in a presentation template store and a repository component that generates information to be presented by a presentation component and enables editing one or more of the presentations.

20. The computer readable storage medium of claim 19, the operations further comprising:
exporting the presentations to the portfolios associated to the plurality of students according to the educational and the social activities online of each student; and
displaying a comment tool that displays comments made from other students and teachers regarding the presentations.
